(19) United States
(12) Patent Application Publication
(10) Pub. No.: US 2026/0303562 A1
(43) Pub. Date: Oct. 1, 2026

(54) OPTIMIZING RETRIEVAL OF AN EXTERNAL IP ADDRESS OF USER EQUIPMENT IN A COMMUNICATION SYSTEM

(71) Applicants: Centre of Excellence in Wireless Technology, Chennai (IN); Indian Institute of Technology Madras (IIT Madras), Chennai (IN)

(72) Inventors: Antony Varghese Mampilly, Chennai (IN); Lokesh Sharath Chandra Borella, Chennai (IN); Harini Shree Velmurugan, Chennai (IN); Anusuya Balasubramanian, Chennai (IN); Jeniston Deviraj Klutto Milleth, Chennai (IN); Bhaskar Ramamurthi, Chennai (IN)

(21) Appl. No.: 19/632,257

(22) Filed: Mar. 28, 2026

(30) Foreign Application Priority Data
Mar. 28, 2025 (IN) 202541030079

(51) Int. Cl. H04L 61/2514

(52) U.S. Cl. CPC H04L 61/2514

(57) ABSTRACT

The present invention relates to a method for optimizing retrieval of an external IP address of a UE in a communication system (1000) by a session managing node (118). The method includes receiving, from a service consumer node (114), a first service request for retrieval of the external IP address of a PDU session of the UE. The first service request includes an identifier of the UE and first plurality of attributes. The first plurality of attributes includes a SUPI, a PDU session identifier, an IP address of a remote end, and at least one of an indicator and an event ID requesting for the external IP address of the UE. Further, the method includes determining a NAT information exposing node (120) that provides the NAT information of the PDU session of the UE. Further, the method includes sending a first service response to the service consumer node (114).

### FIELD OF THE INVENTION

The present invention generally pertains to communication methods and systems, and more particularly to a method and system for optimizing retrieval of an external Internet Protocol (IP) address associated with user equipment (UE) operating within a communication system. This application is based on and claims priority to Indian Application No. 202541030079 filed on Mar. 28, 2025, the contents of which are incorporated herein by reference.

### BACKGROUND

In a fifth-generation (5G) communication network based on 3rd Generation Partnership Project (3GPP) standards, a core network includes multiple network functions configured to support session management, user data management, analytics generation, and user-plane traffic handling. A Session Management Function (SMF) is responsible for establishment, modification, and release of Protocol Data Unit (PDU) sessions for a User Equipment (UE), while a User Plane Function (UPF) handles forwarding of user-plane traffic between the UE and a data network (DN). A Network Data Analytics Function (NWDAF) may collect application-related information from an Application Function (AF) in order to generate analytics associated with network performance, session behavior, or user experience. For obtaining such information, the AF may need to identify a UE session using a DN-facing UE Internet Protocol (IP) address corresponding to the UE.

In existing systems, the AF generally receives a UE identifier such as a Subscription Permanent Identifier (SUPI) or a Generic Public Subscription Identifier (GPSI), whereas application data at the AF is identified using the DN-facing UE IP address. Accordingly, the AF is required to obtain the DN-facing UE IP address corresponding to the UE identifier. For this purpose, the AF interacts with multiple network functions, such as a Unified Data Management (UDM) node for obtaining serving Session Management Function details, the Session Management Function for obtaining a UE private IP address, and, where Network Address Translation (NAT) is enabled, a User Plane Function for obtaining a translated public IP address corresponding to the UE private IP address. Thus, the existing approach involves multiple signaling exchanges across different network functions before the AF can retrieve the required application data.

Such existing procedures suffer from several technical limitations. First, the AF is required to communicate with multiple network functions, thereby increasing signaling overhead, processing burden, and latency in obtaining the DN-facing UE IP address. Second, where NAT is enabled, the AF may need to first obtain a UE private IP address before obtaining a public or NATed IP address, which is undesirable in deployments where operators prefer not to expose the UE private IP address. Third, the AF may need prior knowledge of whether NAT is enabled for the data flow of interest in order to select an appropriate retrieval procedure. Further, the existing approach is generally limited to ongoing PDU sessions and is not suitably adapted for future PDU sessions. Furthermore, the procedure is inefficient when application data is to be obtained for a group of UEs, since the signaling sequence may need to be repeated separately for each UE.

Hence, there is need of a method and system for providing an optimized procedure(s) which can be used by the AF to obtain the DN-facing UE IP address which addresses the above gaps.

### SUMMARY

The principal object of the invention herein is to provide a method and a communication system for optimizing retrieval of an external Internet Protocol (IP) address of a User Equipment (UE) in a communication system.

Another object of the invention herein is to provide that a new event—“DN-facing UE IP address”—is added in Nudm_EventExposure service that could be invoked by an AF to obtain DN-facing UE IP address. When the AF invokes Nudm_EventExposure_Subscribe service operation for the new event, a UDM shall invoke the Nsmf_EventExposure service of SMF to fetch DN-facing UE IP address. The AF does the invocation or interaction directly or through the NEF. The DN-facing UE IP address is an external IP address of the UE.

Another object of the invention herein is to provide that a new event—“DN-facing UE IP address”—is also proposed in a Nsmf_EventExposure service. When a Nsmf_EventExposure_Subscribe is invoked by the UDM for this event, the SMF invokes Nupf_EventExposure service of a UPF to get the UE public IP address, provided NAT exposure is enabled for the serving UPF.

Another object of the invention herein is to provide that if the AF interacts with the core through the NEF, a Nnef_UEAddress_Subscribe service operation should be enhanced to provide GPSI/External group identifier in the Nnef_UEAddress_Subscribe request.

In an aspect, the present invention provides a method for optimizing retrieval of an external Internet Protocol (IP) address of a User Equipment (UE) in a communication system. The method includes receiving, by a session managing node from a service consumer node, a first service request for retrieval of the external IP address of a Protocol Data Unit (PDU) session of the UE. The first service request includes an identifier of the UE and first plurality of attributes. The first plurality of attributes includes a Subscription Permanent Identifier (SUPI), a Protocol Data Unit (PDU) session identifier, an IP address of a remote end, and at least one of an indicator and an event ID requesting for the external IP address of the UE. Further, the method includes determining, by the session managing node, a Network Address Translation (NAT) information exposing node that provides the NAT information of the PDU session of the UE. Further, the method includes sending, by the session managing node, a first service response to the service consumer node. In an embodiment, the first service response can be a response including the external IP address of the PDU session of the UE, when NAT exposure is supported by the NAT information exposing node for the PDU session of the UE. The external IP address includes one of: i) NATed IP address of the PDU session of the UE received from the NAT information exposing node; and ii) private IP address of the PDU session of the UE when an error was received from the NAT information exposing node. In an embodiment, the first service response can be an error response indicating that the external IP address of the PDU session of the UE cannot be retrieved, when NAT exposure is not supported by any NAT information exposing node for the PDU session of the UE.

In another aspect, the present invention provides a method for optimizing retrieval of an external IP address of one or more UEs in a communication system. The method includes receiving, by a user data managing node from a service consumer node, a first service request for retrieval of the external IP address of the one or more UEs, targeting one of: an ongoing and a future PDU session of the one or more UEs. The first service request includes a first plurality of attributes. The first plurality of attributes includes at least one of a General Public Subscription Identifier (GPSI) and a Subscription Permanent Identifier (SUPI), Data Name Network (DNN), an IP address of a remote end, and at least one of an event and an indicator requesting for the external IP address of the PDU session of a UE of the one or more UEs. Further, the method includes storing, by the user data managing node, the first service request. Further, the method includes sending, by the user data managing node, a first service response to the service consumer node. The first service response includes one of: an error response; and a service response including the external IP address of the UE.

In yet another aspect, the present invention provides a method for optimizing retrieval of an external IP address of one of more UEs in a communication system. The method includes receiving, by a network exposure gateway node from an Application Function (AF) node, a first service request for retrieval of the external IP address of the one or more UEs, targeting one of an ongoing and a future Protocol Data Unit (PDU) session. The first service request includes first plurality of attributes. The first plurality of attributes includes of a GPSI of the one or more UEs, an AF identifier, an IP address of a remote end, and an indicator requesting for the external IP address of the PDU session of a UE of the one or more UEs. Further, the method includes sending, by the network exposure gateway node to the AF node, a first service response including one of: a service response including the external IP address of the UE; and an error response, when the external IP address of the UE cannot be retrieved.

In yet another aspect, the present invention provides a method for optimizing retrieval of an external IP address of one or more UEs for an ongoing PDU session in a communication system. The method includes receiving, by a network gateway exposure node, a first service request from an Application Function (AF) node, for retrieval of the external IP address of the one or more UEs, targeting one of an ongoing and a future Protocol Data Unit (PDU) session. The first service request includes a first plurality of attributes. The first plurality of attributes includes a General Public Subscription Identifier (GPSI) of one or more UEs, an AF identifier, an IP address of a remote end and an indicator requesting the external IP address of the PDU session of a UE of the one or more UEs. Further, the method includes determining, by the network exposure gateway node, a serving session managing node handling a PDU session established for a UE of the one or more UEs, by sending a second service request to a user data management node, for one or more UEs. The second service request includes a second plurality of attributes. The second plurality of attributes includes at least one of the GPSI and a SUPI of one or more UEs, an IP address of the remote end, Data Network Name (DNN), slice identifier and at least one of an indicator and event requesting for the external IP address of the PDU session of a UE of the one or more UEs. Further, the method includes receiving, by the network exposure gateway node, a second service response, where the second service response, includes the address of the serving session managing node and a PDU session identifier (ID). Further, the method includes sending, by the network exposure gateway node to the serving session managing node, a third service request, for the retrieval of the external IP address of the PDU session of the UE. The third service request includes a third plurality of attributes, where the third plurality of attributes includes the IP address of the remote end, a Subscription Permanent Identifier (SUPI), a PDU session ID, and at least one of an indicator and event ID requesting for the external IP address of the PDU session of the UE. Further, the method includes determining, by the session managing node, a Network Address Translation (NAT) information exposing node providing the NAT information of the PDU session of the UE. The method includes sending, by the session managing node, one of: a first error response to the network exposure gateway node when NAT information exposure is not supported by the NAT information exposing node for the PDU session of the UE; and a fourth service request to the NAT information exposing node. The fourth service request including fourth plurality of attributes, for retrieval of NATed IP address of the PDU session of the UE. The fourth plurality of attributes includes a private IP address of the UE, an IP address of a remote end, an indicator for immediate reporting and an event ID indicating a request for NATed IP address of the PDU session of the UE.

In yet another aspect, the present invention provides a method for optimizing retrieval of an external IP address of one or more UEs for one of an ongoing and a future PDU session in a communication system. The method includes receiving, by a network exposure gateway node from an Application Function (AF) node, a first service request for retrieval of the external IP address of one of the ongoing and future PDU sessions for the one or more UEs. The first service request includes first plurality of attributes. The first plurality of attributes includes a General Public Subscription Identifier (GPSI) for the one or more UEs, an AF identifier (ID), an IP address of a remote end, and an indicator requesting for the external IP address of the PDU session of a UE of the one or more UEs. Further, the method includes sending, by the network exposure gateway node to a user data managing node, a second service request for retrieval of the external IP address of one of ongoing and future PDU session for the one or more UEs in response to receiving the first service request. The second service request includes a second plurality of attributes, where the second plurality of attributes includes at least one of the GPSI and a Subscription Permanent Identifier (SUPI) of one or more UEs, Data Name Network (DNN), slice identifier, an IP address of the remote end, and at least one of an event and an indicator requesting for the external IP address of the PDU session of a UE of the one or more UEs. Further, the method includes determining, by the user data managing node, in response to receiving the second service request, the session managing node handling a PDU session of the UE, based on the attributes including the second plurality of attributes. Further, the method includes sending, by the user data managing node to the determined session managing node, a third service request for retrieval of the external IP address of the PDU session of the UE. The third service request includes a third plurality of attributes, where the third plurality of attributes includes the SUPI, a PDU session ID, the IP address of the remote end, and at least one of an indicator and event ID requesting for the external IP address of the UE. Further, the method includes determining, by the session managing node, a Network Address Translation (NAT) information exposing node providing the NAT information of the PDU session of the UE. Further, the method includes sending, by the session managing node to the user data managing node, one of: a first error response when NAT exposure is not supported by any NAT information exposing node for the PDU session of the UE; and a first service response when the NAT exposure is supported for the PDU session of the UE in the NAT information exposing node. The first service response includes the external IP address of the PDU session of the UE. The external IP address includes one of: a) NATed IP address of the PDU session of the UE when NATed IP address of the PDU session of the UE was received from the NAT information exposing node when NATing is enabled for the PDU session of the UE; and b) private IP address of the PDU session of the UE when an error was received from the NAT information exposing node indicating that NAT is not enabled for the requested PDU session of the UE.

In yet another aspect, the present invention provides a session managing node for optimizing retrieval of an external IP address of a UE in a communication system. The session managing node includes an external IP address controller connected to a memory and a processor. The external IP address controller receives, from a service consumer node, a first service request for retrieval of the external IP address of a Protocol Data Unit (PDU) session of the UE. The first service request includes an identifier of the UE and first plurality of attributes, where the first plurality of attributes includes a Subscription Permanent Identifier (SUPI), a Protocol Data Unit (PDU) session identifier, an IP address of a remote end, and at least one of an indicator and an event ID requesting for the external IP address of the UE. Further, the external IP address controller determines a NAT information exposing node that provides the NAT information of the PDU session of the UE. Further, the external IP address controller sends a first service response to the service consumer node. The first service response can be a response including the external IP address of the PDU session of the UE, when NAT exposure is supported by the NAT information exposing node for the PDU session of the UE. The external IP address includes one of: i) NATed IP address of the PDU session of the UE received from the NAT information exposing node; and ii) private IP address of the PDU session of the UE when an error was received from the NAT information exposing node. In another embodiment, the first service response can be an error response indicating that the external IP address of the PDU session of the UE cannot be retrieved, when NAT exposure is not supported by any NAT information exposing node for the PDU session of the UE.

In yet another aspect, the present invention provides a user data managing node for optimizing retrieval of an external IP address of UE in a communication system. The user data managing node includes an external IP address controller connected to a memory and a processor. The external IP address controller receives, from a service consumer node, a first service request for retrieval of the external IP address of the one or more UEs, targeting one of: an ongoing and a future Protocol Data Unit (PDU) session of the one or more UEs. The first service request includes first plurality of attributes, where the first plurality of attributes includes at least one of a General Public Subscription Identifier (GPSI) and a Subscription Permanent Identifier (SUPI), Data Name Network (DNN), an IP address of a remote end, and at least one of an event and an indicator requesting for the external IP address of the PDU session of a UE of the one or more UEs. Further, the external IP address controller stores the first service request. Further, the external IP address controller sends, a first service response to the service consumer node. The first service response includes one of: an error response; and a service response including the external IP address of the UE.

In yet another aspect, the present invention provides a network exposure gateway node for optimizing retrieval of an external IP address of a UE in a communication system. The network exposure gateway node includes an external IP address controller connected to a memory and a processor. The external IP address controller receives, from an Application Function (AF) node, a first service request for retrieval of the external IP address of the one or more UEs, targeting one of an ongoing and a future Protocol Data Unit (PDU) session, where the first service request includes first plurality of attributes, where the first plurality of attributes includes of a General Public Subscription Identifier (GPSI) of the one or more UEs, an AF identifier, an IP address of a remote end, and an indicator requesting for the external IP address of the PDU session of a UE of the one or more UEs. Further, the external IP address controller sends, to the AF node, a first service response including one of: a service response including the external IP address of the UE; and an error response, when the external IP address of the UE cannot be retrieved.

These and other aspects of the embodiments will be understood from the following description and drawings, which illustrate preferred embodiments with specific details but do not limit the scope; all modifications within the embodiments are included.

### BRIEF DESCRIPTION OF FIGURES

These and other features, aspects, and advantages of the present invention are illustrated in the accompanying drawings, throughout which like reference letters indicate corresponding parts in the various figures. The embodiments herein will be better understood from the following description with reference to the drawings, in which:

FIG. 1 illustrates a general operation of a Network Data Analytics Function (NWDAF) in a communication system according to prior art.

FIG. 2 and FIG. 3 illustrate a NAT in 5G-CN. If NAT is enabled, DN-facing UE IP address is UE private IP address; otherwise, DN-facing UE IP address is UE public IP address according to prior art.

FIG. 4 illustrates an existing procedure for acquisition of UE public IP address by the AF that interacts directly with the NFs according to prior art.

FIG. 5 illustrates an existing scheme for acquisition of UE public IP address by the AF according to prior art.

FIG. 6 illustrates operations of the user data managing node according to prior art.

FIG. 7 illustrates operations of the session managing node according to prior art.

FIG. 8 illustrates the AF retrieving UE private IP address corresponding to the UE identifier from the core network according to prior art.

FIG. 9 illustrates the AF retrieving the UE public IP address corresponding to the UE private IP address from the core network according to prior art.

FIG. 10 is a block diagram illustrating a session managing node for optimizing retrieval of an external Internet Protocol (IP) address of a UE in a communication system according to embodiments as disclosed herein.

FIG. 11 is a block diagram illustrating a user data managing node for optimizing retrieval of the IP address of the UE in the communication system according to embodiments as disclosed herein.

FIG. 12 is a block diagram illustrating a network exposure gateway node for optimizing retrieval of the IP address of the UE in the communication system according to embodiments as disclosed herein.

FIG. 13 is a flow chart illustrating a method implemented by the session managing node for optimizing retrieval of the external IP address of the UE in the communication system according to embodiments as disclosed herein.

FIG. 14 is a flow chart illustrating a method implemented by the user data managing node for optimizing retrieval of the IP address of the UE in the communication system according to embodiments as disclosed herein.

FIG. 15 is a flow chart illustrating a method implemented by the network exposure gateway node for optimizing retrieval of the IP address of the UE in the communication system according to embodiments as disclosed herein.

FIG. 16 and FIG. 17 illustrate an overall process of a method for optimizing retrieval of the IP address of the UE in the communication system according to embodiments as disclosed herein.

FIG. 18 is an example sequence diagram illustrating an updated procedure for providing DN-facing UE IP address to the AF that can interact directly with the NFs according to embodiments as disclosed herein.

FIG. 19 is an example sequence diagram illustrating an updated procedure for delivering DN-facing IP address to the AF interacting with the NFs via the NEF according to embodiments as disclosed herein.

FIGS. 20A-C, 21A-C, and 22A-C are example sequence diagrams illustrating a step-by-step process for optimizing retrieval of the IP address of the UE in the communication system according to embodiments as disclosed herein.

Like reference numerals denote like elements. The drawings are simplified and not necessarily to scale; certain dimensions can be exaggerated to clarify aspects of the invention. Conventional symbols can be used, and only details pertinent to understanding the embodiments are shown to avoid obscuring information already apparent to skilled artisans.

### DETAILED DESCRIPTION OF INVENTION

The embodiments herein and the various features and advantageous details thereof are explained more fully with reference to the non-limiting embodiments illustrated in the accompanying drawings and described in the following description. Descriptions of well-known components and processing techniques are omitted so as to not unnecessarily obscure the embodiments herein. Further, the various embodiments described herein are not necessarily mutually exclusive, as some embodiments can be combined with one or more other embodiments to form new embodiments. The term “or” as used herein refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is known in the field, embodiments can be described and illustrated in terms of blocks which carry out a described function or functions. These blocks, which can be referred to herein as managers, units, modules, controllers, hardware components or the like, are physically implemented by analog and/or digital circuits such as logic gates, integrated circuits, microprocessors, microcontrollers, memory circuits, passive electronic components, active electronic components, optical components, hardwired circuits and the like, and can optionally be driven by firmware and software. The circuits may, for example, be embodied in one or more semiconductor chips, or on substrate supports such as printed circuit boards and the like. The circuits constituting a block can be implemented by dedicated hardware, or by a processor, such as one or more programmed microprocessors and associated circuitry, or by a combination of dedicated hardware to perform some functions of the block and a processor to perform other functions of the block. Each block of the embodiments can be physically separated into two or more interacting and discrete blocks without departing from the scope of the disclosure. Likewise, the blocks of the embodiments can be physically combined into more complex blocks without departing from the scope of the disclosure. In an embodiment, such blocks are implemented using cooperating hardware circuitry configured to perform control, signaling, data handling, and interface management functions within a mobile communication network.

Referring now to the drawings, and more particularly to FIGS. 1 through 22c, where similar reference characters denote corresponding features consistently throughout the figures, there are shown various embodiments.

The 5G Core Network (5G-CN) comprises various network functions (NFs) interacting with each other over a Service-Based Architecture (SBA) interface. Each NF has specific functionality and offers a set of services to other NFs. Among them, the Network Data Analytics Function (NWDAF) is a key NF that is used to collect data from other relevant NFs and produce analytics such as network performance improvement and user experience improvement. For a specific use case, one of the NFs from which the NWDAF collects data is an Application Function (AF), which is a 3GPP representation of an application in an operator network. The NWDAF requests User Equipment (UE) application data from the AF by providing a UE ID, which could be either a Subscription Permanent Identifier (SUPI) or a Generic Public Subscription Identifier (GPSI). However, the AF identifies the UE application data using the Data Network (DN)-facing UE IP address, which is the UE IP address recognized by the external DN. Therefore, the AF needs to determine the DN-facing UE IP address corresponding to the UE ID provided by the NWDAF. The existing procedure requires the AF to interact with multiple NFs such as Unified Data Management (UDM), Session Management Function (SMF), and User Plane Function (UPF) to obtain the DN-facing UE IP address for the UE identified by the UE ID provided by the NWDAF. Such multiple NF interactions increase signaling exchanges and processing burden on the AF.

In the prior-art arrangement, the AF interacts with the UDM, which contains information related to the SMF responsible for managing the session between the UE and the DN. However, even after obtaining information from the UDM, the AF still relies on further interaction with other NFs to determine the DN-facing UE IP address. As a result, the AF does not obtain the DN-facing UE IP address through a single NF interaction. Further, the existing procedure is limited in handling ongoing and future PDU sessions in a unified manner, and is also inefficient when UE IP addresses of a group of UEs are to be queried.

The UDM is the central entity having information about PDU details of the UE such as PDU session ID, DNN, S-NSSAI, and serving SMF address, which are provided during the PDU session establishment procedure. With this information, the UDM can invoke the subsequent service of the serving SMF. However, in the existing scheme, the AF still follows a service chain involving multiple NFs for obtaining the DN-facing UE IP address. Thus, the prior-art procedure remains dependent on multiple service invocations and does not avoid repeated NF interactions.

The 3rd Generation Partnership Project (3GPP) is a global forum responsible for the development of mobile telecommunication standards. In a fifth generation (5G) network, a standard telecommunication system following 3GPP standards consists of multiple components namely a UE, a gNodeB, and a fifth-generation core network (5G-CN). The 5G-CN serves as a control system of a 5G network that manages data management, mobility control, and policy enforcement within the 5G network.

A Session Management Function (SMF) is a key network function (NF) in the 5G-CN that establishes, modifies, and releases Protocol Data Unit (PDU) sessions that allow the UE to send and receive data towards a data network (DN) (110). The SMF assigns the UE IP address and selects the appropriate User Plane Function (UPF) to route data traffic between the UE and the DN. The UPF serves as a gateway between the UE and an external data network. When the SMF establishes a PDU session for the UE, it registers itself with a Unified Data Management (UDM) as a serving entity for the PDU session of the UE. The UDM is a key NF in the 5G-CN that serves as the centralized data management for subscriber and network related data. The registration request sent by the SMF to the UDM contains Subscription Permanent Identifier (SUPI), SMF identifier (ID), SMF address, and other PDU related details.

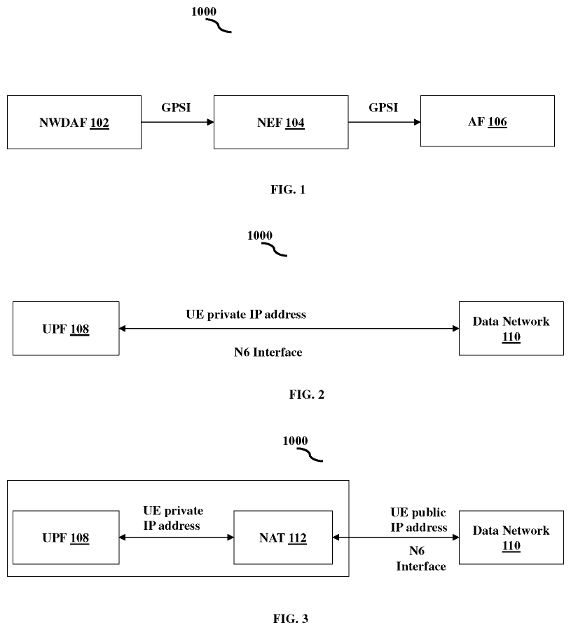

In the 5G-CN, the UPF is a crucial NF responsible for packet forwarding and Quality of Service (QoS) enforcement. The network interface between the UPF and the DN, as shown in FIG. 2 and FIG. 3, is called N6 interface. A DN-facing UE IP address is the IP address of the PDU session of the UE as seen by the DN. The IP address assigned to the UE internally by the 5G-CN is called UE private IP address.

FIG. 1 illustrates general operations of a Network Data Analytics Function (NWDAF) (102) in a communication system (1000), according to prior art. In the 5G-core network, the NWDAF (102) is a key Network Function (NF) that is used to collect data from relevant NFs and produce analytics to improve network performance and user experience. One of the NFs from which the NWDAF (102) collects data is the Application Function (AF) (106). The AF (or AF node) (106) is a 3GPP representation of an application. The term “AF” and “AF node” used interchangeably in the patent disclosure. The AF (106) can interact with NFs in the 5G core network. There are two types of AFs such as trusted AF, i.e., AFs that can connect directly to any NF in the core network, and external AF, i.e., AFs that are interfaced to the core network through a gateway called Network Exposure Function (NEF).

The NWDAF (102) may provide the SUPI to the trusted AF, and Generic Public Subscription Identifier (GPSI) to the external AF, and request it to provide the UE information. However, the UE information in the AF (106) is identified by the DN-facing UE IP address. Therefore, the AF (106) finds the UE IP address corresponding to the SUPI or GPSI provided by the NWDAF (102) in order to retrieve the UE information. The AF (106) has a database with the UE data identified by the DN-facing UE IP address. In an example, Table 1 represents UE IP address and the UE traffic data.

TABLE 1

| UE IP address | UE traffic data |
|---|---|
| UE_ip_addr0 | UE_data0 |
| UE_ip_addr1 | UE_data1 |
| UE_ip_addr2 | UE_data2 |

An operator may enable a Network Address Translation (NAT) in the 5G-CN. The NAT (112) is a process in networking to modify the IP address of devices. The operator may enable the NAT (112) because the NAT (112) allows multiple UEs to access external networks using a single external IP address. This feature is especially useful in IPv4 networks which have a limited number of external addresses. The NAT (112) is also used for privacy.

FIG. 2 and FIG. 3 illustrate NAT in the 5G-CN. If the NAT is not enabled, the DN-facing UE IP address is the UE private IP address. If the NAT is enabled, the UE private IP address is translated to UE public IP address or NATed IP address and then exposed to the DN, according to prior art.

If the NAT is not enabled, then the UE private IP address is known to the DN. However, if the NAT is enabled, then the UE private IP address is translated to UE public IP address or NATed IP address and then exposed to the DN. In other words, as shown in FIG. 2 and FIG. 3, if the NAT is not enabled, then the DN-facing UE IP address is the UE private IP address, else it is the UE public IP address. In the 3GPP standards, the UPF (108) supports exposure of UE public IP address.

In the 5G-CN, the NWDAF (102) may interact with the AF (106) to collect UE application data for the purpose of generating analytics. This data could be application-specific data such as session usage or user-experience data such as Quality of Experience (QoE). The NWDAF (102) queries the AF (106) for the UE application data by identifying the target UE with its SUPI. In case the AF (106) is authorized by the NEF (104) to interact with the 5G core, the AF (106) provides the UE identifier known as GPSI to the NEF. The GPSI is a UE identifier just like SUPI. However, unlike SUPI, the GPSI is used as a UE identifier by the AFs interacting indirectly with the 5G-CN via the NEF. The AF (106) identifies UE application data by the UE IP address. Therefore, the AF (106) finds the UE IP address of the specific session corresponding to the SUPI in order to retrieve the UE application data.

The NWDAF (102) requests the AF (106) to provide UE application data by providing the UE's SUPI. However, since the UE application data present in the AF (106) is identified by the DN-facing UE IP address, the AF (106) needs to translate the SUPI obtained from the NWDAF (102) to the corresponding DN-facing UE IP address. The DN-facing UE IP address could be either UE private IP address, if the NAT is disabled, or UE public IP address, if the NAT is enabled. Since the SMF (118a) responsible for PDU session establishment assigns the UE private IP address, the AF (106) contacts the SMF (118a) to obtain it. The AF (106) acquires the relevant SMF contact details, such as SMF ID and SMF address, from the UDM (116a), which maintains a record of SMF instances in the network. If the NAT is enabled, the AF (106) determines the UE public IP address. As this mapping is present in the UPF (108), the AF (106) requests the UPF (108) to provide the UE public IP address by providing UE private IP address as input. Accordingly, the AF (106) depends on multiple sequential interactions to obtain the DN-facing UE IP address.

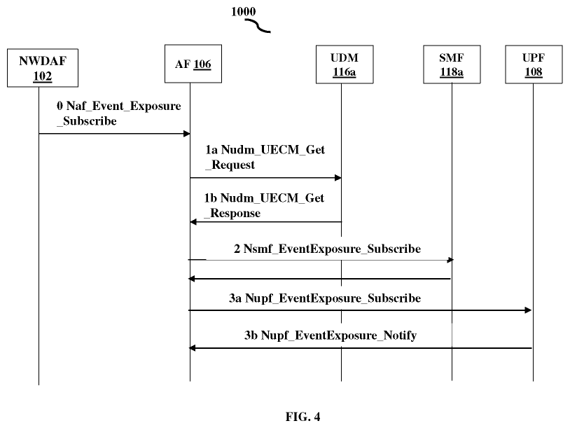

The existing procedure by which the AF (106) acquires the DN-facing UE IP address is shown in FIG. 4. This procedure is applicable to the AF (106) that can interact directly with NFs in the 5G-CN. FIG. 4 illustrates an existing procedure for acquisition of UE public IP address by the AF (106) that interacts directly with the NFs, according to prior art.

In the Step 0, the NWDAF (102) invokes a Naf_EventExposure_Subscribe service and requests UE application data from the AF (106) by providing the SUPI, DNN (Data Network Name), and S-NSSAI (Single Network Slice Selection Assistance Information).

In Steps 1a and 1b, the UDM (116a) keeps track of the SMF (118a) serving the PDU sessions of a given UE. Therefore, the AF (106) requests the UDM (116a) using Nudm_UECM_Get_Request service to provide the SMF ID and PDU session ID of the SMF (118a) that has established the session. The AF (106) provides inputs such as SUPI, DNN, and S-NSSAI in this request. The UDM (116a) responds with the SMF ID, SMF address, and PDU session ID.

In Step 2, the serving SMF (118a) allocates UE private IP addresses and selects the appropriate UPF (108). Therefore, the AF (106) interacts with the SMF (118a) and requests the UE private IP address by invoking the Nsmf_EventExposure_Subscribe request by providing inputs such as SUPI, DNN, S-NSSAI, and PDU session ID. The UE private IP address is supplied by the SMF (118a) in the response.

In Steps 3a and 3b, if the NAT is enabled, then the AF (106) determines the UE public IP address corresponding to the UE private IP address, which is information available in the UPF (108). Therefore, the AF (106) discovers the UPF (108) for which the NAT exposure is enabled and requests the UE public IP address of the UE private IP address by invoking the Nupf_EventExposure_Subscribe service. The UPF (108) responds with the UE public IP address. A similar procedure is employed by the AF (106) interacting indirectly with the 5G-CN through the NEF.

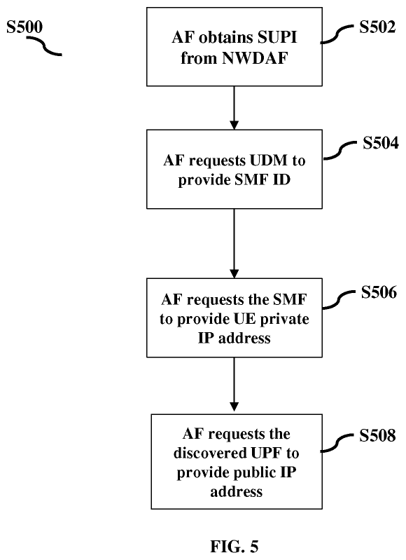

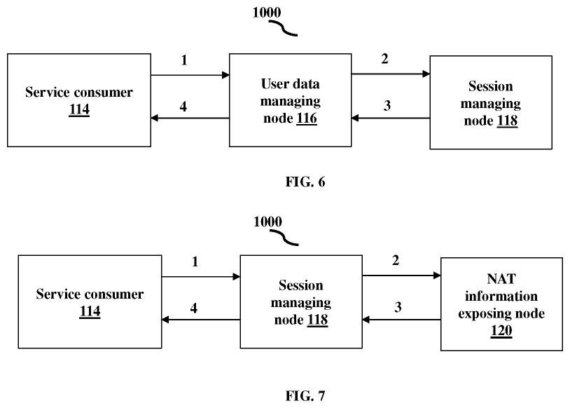

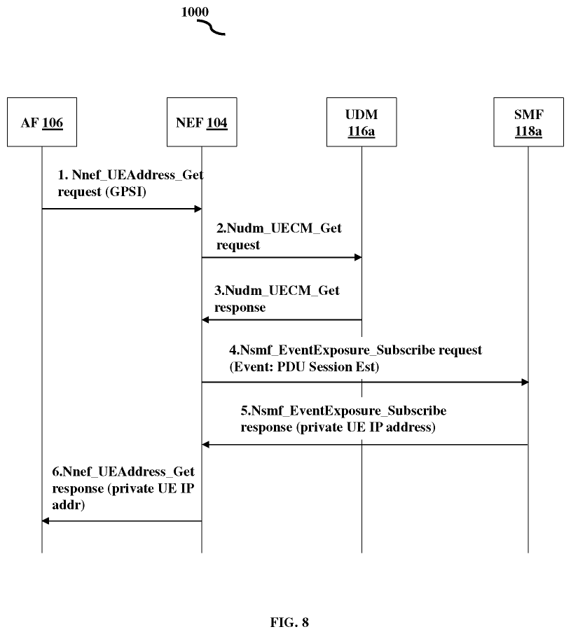

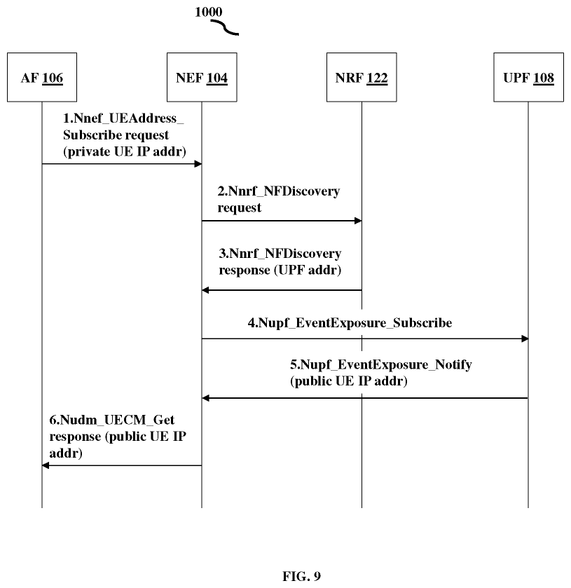

The drawback of the existing scheme is that the AF (106) communicates with multiple NFs to acquire the DN-facing IP address, which leads to increased processing load on the AF. FIG. 5 illustrates an existing scheme for acquisition of UE public IP address by the AF, according to prior art, simplified to focus on the AF's actions. At S502, the AF (106) obtains SUPI from the NWDAF (102). At S504, the AF (106) requests the UDM (116a) to provide the SMF ID. At S506, the AF (106) requests the SMF (118a) to provide UE private IP address. At S508, the AF (106) requests the discovered UPF (108) to provide public IP address. Thus, the AF (106) undergoes multiple signaling procedures before obtaining the DN-facing UE IP address.

Another limitation of the existing procedure is that, if the NWDAF (102) has requested UE application data for multiple UEs, the AF (106) repeats the entire procedure to obtain DN-facing UE IP address for each UE. This is because the Nudm_UECM_Get_Request service applies to a single UE and not to multiple UEs. Therefore, the existing scheme is not optimized for a group of UEs.

Another limitation of the existing procedure is that the AF (106) can only determine the DN-facing UE IP address for an active PDU session. Therefore, the AF (106) repeats the procedure every time the PDU session is disconnected and connected again, as the Nudm_UECM_Get_Request service applies to an ongoing PDU session and not to a future PDU session. Therefore, the existing scheme does not efficiently support future PDU sessions.

FIG. 6 illustrates operations of a user data managing node (116), according to prior art. At step 1, a service consumer (or service consumer node) (114) sends a service request for retrieval of the external IP address of one or more UEs for a future or ongoing PDU session to the user data managing node (116). At step 2, the user data managing node (116) sends the service request for retrieval of external IP address of the UE session to the session managing node (118). At step 3, the session managing node (118) sends the service response comprising the external IP address of the UE to the user data managing node (116). At step 4, the user data managing node (116) sends the service response providing the external IP address of the UE to the service consumer (114).

FIG. 7 illustrates operations of the session managing node (118), according to prior art. At step 1, the service consumer (114) sends the service request for retrieval of the external IP address of a UE session to the session managing node (118). At step 2, the session managing node (118) sends the service request for retrieval of the NATed UE IP address to the NAT information exposing node (120). At step 3, the NAT information exposing node (120) sends the service response comprising either an error or the NATed UE IP address to the session managing node (118). At step 4, the session managing node (118) sends the service response providing the external IP address of the UE sessions to the service consumer (114).

FIG. 8 illustrates the AF (106) retrieving UE private IP address corresponding to the UE identifier from the core network, according to prior art. At step 1, the AF (106) sends a Nnef_UEAddress_Get request including GPSI to the NEF (104). At step 2, the NEF (104) sends a Nudm_UECM_Get request to the UDM (116a). At step 3, the UDM (116a) sends a Nudm_UECM_Get response to the NEF (104). At step 4, the NEF (104) sends a Nsmf_EventExposure_Subscribe request including Event: PDU Session Est to the SMF (118a). At step 5, the SMF (118a) sends a Nsmf_EventExposure_Subscribe response including private UE IP address to the NEF (104). At step 6, the NEF (104) sends a Nnef_UEAddress Get response including private UE IP address to the AF (106).

FIG. 9 illustrates the AF (106) retrieving the UE public IP address corresponding to the UE private IP address from the core network, according to prior art.

At step 1, the AF (106) sends a Nnef_UEAddress_Subscribe request including private UE IP address to the NEF (104). At step 2, the NEF (104) sends a Nnrf_NFDiscovery request to a Network Repository Function (NRF) (122). At step 3, the NRF (122) sends a Nnrf_NFDiscovery response including UPF address to the NEF (104). At step 4, the NEF (104) sends a Nupf_EventExposure_Subscribe to the UPF (108). At step 5, the UPF (108) sends the Nupf_EventExposure_Notify including the public UE IP address to the NEF (104). At step 6, the NEF (104) sends the Nnef_UEAddress_Subscribe response including public UE IP address to the AF (106).

If the NAT is not enabled, the AF (106) uses the operations in FIG. 8 to obtain the DN-facing UE IP address. If the NAT is enabled, then both the procedures explained in FIG. 8 and FIG. 9 are invoked sequentially. In the existing method to fetch the DN-facing UE IP address, the following gaps are identified: if the NAT is enabled, the AF (106) retrieves the private UE IP address before it can request for public UE IP address, whereas operators prefer not to expose the private UE IP address; the AF (106) should know if the NAT is enabled for the data flow of its interest to choose the appropriate procedure; the method supports only ongoing PDU session and not future PDU session(s); the AF (106) interacts with multiple NFs such as UDM (116a), SMF (118a), NRF (122), and UPF (108); and the method is not optimized for a group of UEs. Accordingly, the prior-art method suffers from increased NF interactions, increased processing burden on the AF, lack of support for efficient handling of future PDU sessions, and inefficiency in handling a group of UEs.

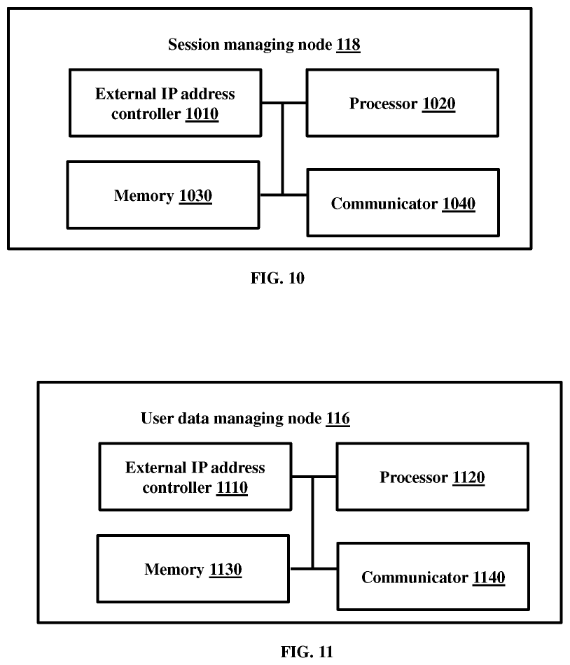

FIG. 10 is a block diagram illustrating a session managing node (118) for optimizing retrieval of an external Internet Protocol (IP) address of a User Equipment (UE) in a communication system (1000), according to embodiments as disclosed herein. The session managing node (118) can be a Session Management Function (SMF) in a 5G network. Further, in a 6G network, the session managing node (118) can be any network function configured to manage a session of the UE and support retrieval of the external IP address of the UE associated with the session. Examples of the UE (100) can include, but are not limited to, Consumer Electronics such as Mobile Phones and Smartphones, Tablets, Wearable Devices, Computing Devices such as Laptops, Notebooks, Desktops, and Workstations, Internet of Things (IoT) Devices, Automotive Systems such as connected cars, Autonomous Vehicles, and Vehicle-to-Everything (V2X) communication devices, Enterprise Devices such as robotics, Specialized Equipment such as Medical Devices and Public Safety Devices, and Media Devices such as Gaming Consoles and Streaming Devices.

Examples of the communication system (1000) include, but are not limited to, Public Land Mobile Networks (PLMNs) supporting radio access technologies such as 2G, 3G, 4G, 5G, and beyond-5G/6G, and may further include non-terrestrial network (NTN) access via satellite systems. In addition, the communication system (1000) may include, in combination or alternatively, wireless local area networks and machine-type communication networks.

The session managing node (118) comprises an external IP address controller (1010), a processor (1020), a memory (1030), and a communicator (1040), which are operatively coupled to each other. In an embodiment, the processor (1020), the memory (1030), the communicator (1040), and the external IP address controller (1010) are interconnected through one or more internal buses, interconnects, or interface circuits for coordinated execution of control, signaling, and data handling operations.

The processor (1020) communicates with the memory (1030), the communicator (1040), and the external IP address controller (1010). The processor (1020) is configured to execute instructions stored in the memory (1030) and to perform various processes associated with operation of the session managing node (118). The processor (1020) can include one or a plurality of processors, and can be implemented as a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU). In an embodiment, the processor (1020) is configured to control service request processing, session-state handling, signaling exchange, and external IP address retrieval operations performed in the session managing node (118).

The memory (1030) is configured to store instructions to be executed by the processor (1020). The memory (1030) can include non-volatile storage elements. Examples of such non-volatile storage elements can include magnetic hard disks, optical disks, floppy disks, flash memories, or forms of electrically programmable memories (EPROM) or electrically erasable and programmable (EEPROM) memories. In addition, the memory (1030) can in some examples be considered a non-transitory storage medium. The term non-transitory can indicate that the storage medium is not embodied in a carrier wave or a propagated signal. However, the term non-transitory should not be interpreted to mean that the memory is non-movable. In some examples, the memory (1030) can be configured to store larger amounts of information. In certain examples, a non-transitory storage medium can store data that can over time change, for example, in Random Access Memory (RAM) or cache. In an embodiment, the memory (1030) stores session-related information, external IP address information, mapping-related information, subscription-related information, and control instructions associated with retrieval of the external IP address of the UE.

The communicator (1040) includes an electronic circuit specific to a standard that enables wired or wireless communication. The communicator (1040) is configured to communicate internally between internal hardware components of the network system and with external devices via one or more networks. In an embodiment, the communicator (1040) is configured to exchange signaling and data with one or more other network functions in the communication system (1000), including the NAT information exposing node (120).

The external IP address controller (1010) is implemented as dedicated hardware circuitry operatively coupled to the processor (1020), the memory (1030), and the communicator (1040). In an embodiment, the external IP address controller (1010) comprises one or more cooperating hardware blocks including a request processing circuit, an address retrieval circuit, a mapping control circuit, a session-state management circuit, a message generation and routing circuit, and an interface control circuit. The request processing circuit is configured to receive and parse a service request associated with retrieval of the external IP address of the UE. The address retrieval circuit is configured to obtain the external IP address corresponding to the UE session. The mapping control circuit is configured to control signaling exchange with the NAT information exposing node (120) for obtaining a NATed UE IP address corresponding to the UE session. The session-state management circuit is configured to maintain session state information associated with retrieval of the external IP address. The message generation and routing circuit is configured to generate and route a service request and a service response associated with retrieval of the external IP address of the UE. The interface control circuit is configured to control hardware-level interfacing between the external IP address controller (1010), the processor (1020), the memory (1030), and the communicator (1040).

In an embodiment, the external IP address controller (1010) further comprises dedicated logic circuits, register sets, buffer memory, comparator circuits, control-state registers, and interface buses for hardware-level control of request parsing, address mapping control, signaling exchange, session-state maintenance, and response generation. In an embodiment, the external IP address controller (1010) is configured as a structurally integrated control block within the session managing node (118) to perform external IP address retrieval and related signaling control for the UE session. Such structural implementation enables the session managing node (118) to perform technical control and signaling operations associated with retrieval and provision of the external IP address of the UE.

The external IP address controller (1010) is implemented by dedicated processing circuitry such as logic gates, integrated circuits, microprocessors, microcontrollers, memory circuits, passive electronic components, active electronic components, optical components, hardwired circuits, or the like. The circuits may, for example, be embodied in one or more semiconductors.

The external IP address controller (1010) receives from a service consumer node (114) a first service request for retrieval of the external IP address of a Protocol Data Unit (PDU) session of the UE. The first service request can be an event exposure subscription request. In a 5G network, the first service request uses an Nsmf_EventExposure Application Programming Interface (API). The first service request includes an identifier of the UE and a first plurality of attributes. The first plurality of attributes includes a SUPI, the PDU session identifier, an IP address of the remote end, and at least one of an indicator and an event ID requesting the external IP address of the UE.

The external IP address controller (1010) determines the NAT information exposing node (120) that provides the NAT information of the PDU session of the UE. The NAT information exposing node (120) can be one of the UPF (108) and a Service Function (SF) in the 5G network.

The external IP address controller (1010) sends a first service response to the service consumer node (114). The first service response can be an event exposure notification. In an embodiment, the first service response is a response including the external IP address of the PDU session of the UE when NAT exposure is supported by the NAT information exposing node (120) for the PDU session of the UE. In an embodiment, the external IP address includes a NATed IP address of the PDU session of the UE received from the NAT information exposing node. In an embodiment, the external IP address includes a private IP address of the PDU session of the UE when an error is received from the NAT information exposing node. In another embodiment, the first service response is an error response indicating that the external IP address of the PDU session of the UE cannot be retrieved when NAT exposure is not supported by any NAT information exposing node (120) for the PDU session of the UE.

In an embodiment, the external IP address controller (1010) sends, by the session managing node (118), to the NAT information exposing node (120) a second service request comprising a second plurality of attributes for retrieval of the NATed IP address of the PDU session of the UE. The second plurality of attributes includes a private IP address of the UE, an IP address of a remote end, an indicator for immediate reporting, and an event ID indicating a request for the NATed IP address of the PDU session of the UE. The second service request can be an event exposure subscription request. The second service request uses a Nupf_EventExposure API in a 5G network. Further, the external IP address controller (1010) receives from the NAT information exposing node (120) a second service response. The second service response can be an event exposure response. The second service response includes a response comprising the NATed IP address of the PDU session of the UE when NAT is enabled for the PDU session of the UE, and the session managing node (118) generates the first service response comprising the NATed IP address of the PDU session of the UE to the service consumer node (114). In another embodiment, the second service response includes a response comprising an error response when NATing is not enabled for the PDU session of the UE, and the session managing node (118) generates the first service response comprising the private IP address of the PDU session of the UE to the service consumer node (114).

Unlike the existing mechanism, the external IP address controller (1010) may further maintain, in association with the first service request, correlation information enabling the mapping between the first plurality of attributes and any subsequently obtained NAT information. For example, the external IP address controller (1010) can store a correlation identifier, the SUPI, the PDU session identifier, and the IP address of the remote end in a local data structure or database. This correlation information allows the external IP address controller (1010) to correctly associate a received NATed IP address or an error indication from the NAT information exposing node (120) with the original first service request received from the service consumer node (114). In some embodiments, the external IP address controller (1010) also stores a validity time or subscription duration, such that the external IP address controller (1010) can determine whether a subsequent NAT exposure event is still relevant for the service consumer node (114), and can discard or ignore stale NAT information when the subscription has expired.

Further, unlike the existing mechanism, the external IP address controller (1010) is further configured to support both immediate, one-time retrieval of the external IP address and continuous, event-based reporting of changes to the external IP address for the same PDU session of the UE. For instance, the first plurality of attributes may include, in addition to the indicator and/or event ID, one or more parameters defining a reporting mode, such as “one-shot” or “continuous,” and optionally a maximum reporting frequency or threshold for triggering a notification when the NATed IP address changes. When continuous reporting is requested, the external IP address controller (1010) may maintain an active subscription with the NAT information exposing node (120) via the Nupf_EventExposure API and forward any subsequent event exposure notifications, including updated NATed IP addresses or error conditions, as corresponding first service responses to the service consumer node (114). In this way, the service consumer node (114) can be kept informed of any changes in the external IP address of the PDU session of the UE without having to repeatedly issue new first service requests

FIG. 11 is a block diagram illustrating a user data managing node (116) for optimizing retrieval of the external Internet Protocol (IP) address of a User Equipment (UE) in the communication system (1000), according to embodiments as disclosed herein. The user data managing node (116) can be a Unified Data Management (UDM) (116a) in a 5G network. Further, in a 6G network, the user data managing node (116) can be any network function configured to store session-related information of the UE and support retrieval of the external IP address of the UE associated with a session.

The user data managing node (116) comprises an external IP address controller (1110), a processor (1120), a memory (1130), and a communicator (1140), which are operatively coupled to each other. In an embodiment, the processor (1120), the memory (1130), the communicator (1140), and the external IP address controller (1110) are interconnected through one or more internal buses, interconnects, or interface circuits for coordinated execution of control, signaling, and data handling operations.

The processor (1120) communicates with the memory (1130), the communicator (1140), and the external IP address controller (1110). The processor (1120) is configured to execute instructions stored in the memory (1130) and to perform processes associated with operation of the user data managing node (116). In an embodiment, the processor (1120) is configured to control service request processing, subscription handling, signaling exchange, and external IP address retrieval operations performed in the user data managing node (116).

The memory (1130) is configured to store instructions to be executed by the processor (1120). In an embodiment, the memory (1130) stores UE-related information, session-related information, serving session managing node information, external IP address information, subscription-related information, and control instructions associated with retrieval of the external IP address of the UE. The memory (1130) can include one or more non-transitory storage media.

The communicator (1140) includes an electronic circuit specific to a standard that enables wired or wireless communication. The communicator (1140) is configured to communicate internally between internal hardware components of the network system and with external devices via one or more networks. In an embodiment, the communicator (1140) is configured to exchange signaling and data with one or more other network functions in the communication system (1000), including the session managing node (118).

The external IP address controller (1110) is implemented as dedicated hardware circuitry operatively coupled to the processor (1120), the memory (1130), and the communicator (1140). In an embodiment, the external IP address controller (1110) comprises one or more cooperating hardware blocks including a request processing circuit, a subscription control circuit, a session information handling circuit, a state management circuit, a message generation and routing circuit, and an interface control circuit. The request processing circuit is configured to receive and parse a service request associated with retrieval of the external IP address of the UE. The subscription control circuit is configured to create, maintain, and manage a subscription associated with retrieval of the external IP address of the UE. The session information handling circuit is configured to identify session-related information associated with the UE and determine a serving session managing node (118) corresponding to the UE. The state management circuit is configured to maintain subscription state information and service processing state information associated with retrieval of the external IP address. The message generation and routing circuit is configured to generate and route a service request to the session managing node (118) and to generate a service response associated with retrieval of the external IP address of the UE. The interface control circuit is configured to control hardware-level interfacing between the external IP address controller (1110), the processor (1120), the memory (1130), and the communicator (1140).

In an embodiment, the external IP address controller (1110) further comprises dedicated logic circuits, register sets, buffer memory, comparator circuits, control-state registers, and interface buses for hardware-level control of request parsing, subscription control, session information handling, signaling exchange, state maintenance, and response generation. In an embodiment, the external IP address controller (1110) is configured as a structurally integrated control block within the user data managing node (116) to perform external IP address retrieval and related signaling control for the UE. Such structural implementation enables the user data managing node (116) to perform technical control and signaling operations associated with retrieval and provision of the external IP address of the UE.

The external IP address controller (1110) is implemented by dedicated processing circuitry such as logic gates, integrated circuits, microprocessors, microcontrollers, memory circuits, passive electronic components, active electronic components, optical components, hardwired circuits, or the like. The circuits may, for example, be embodied in one or more semiconductors.

The external IP address controller (1110) receives, from the service consumer node (114), a first service request for retrieval of the external IP address of the one or more UEs targeting one of an ongoing and a future PDU session of the one or more UEs. The first service request uses a Nudm_EventExposure API in a 5G network. The first service request includes a first plurality of attributes. The first plurality of attributes includes at least one of the GPSI, the SUPI, the DNN, the IP address of the remote end, and at least one of the event and the indicator requesting the external IP address of the PDU session of the UE of the one or more UEs. Furthermore, the external IP address controller (1110) stores the first service request.

In addition, the external IP address controller (1110) sends a first service response to the service consumer node (114). The first service response includes one of an error response and a service response including the external IP address of the UE.

In an embodiment, the external IP address controller (1110) determines the session managing node (118) handling the PDU session established for the UE of the one or more UEs. The external IP address controller (1110) then sends, to the determined session managing node (118), a second service request for the retrieval of the external IP address of the PDU session of the UE. The second service request uses an Nsmf_EventExposure API in a 5G network. The second service request includes a second plurality of attributes, where the second plurality of attributes comprises the SUPI, the PDU session identifier, the IP address of a remote end, and at least one of an event and an indicator requesting the external IP address of the PDU session of the UE.

In an embodiment, the external IP address controller (1110) receives, from the session managing node (118), the external IP address of the PDU session of the UE when the external IP address of the PDU session of the UE is retrieved by the session managing node (118), and a user data managing node (116) generates the first service response comprising the external IP address of the UE. In another embodiment, the external IP address controller (1110) receives, from the session managing node (118), an error indicating failure to retrieve the external IP address of the PDU session of the UE, and the user data managing node (116) generates the first service response comprising the error response.

Unlike to existing system, the external IP address controller (1110) may further be configured to perform validation and correlation of the first plurality of attributes prior to initiating any interaction with the session managing node (118). For example, upon receipt of the first service request from the service consumer node (114), the external IP address controller (1110) can verify that the GPSI and/or SUPI correspond to a valid subscriber, that the DNN is authorized for the identified subscriber, and that the indicated event or indicator requesting the external IP address is supported for the requested PDU session type. In some embodiments, the external IP address controller (1110) may also correlate multiple first service requests associated with the same UE or PDU session, and maintain state information indicating pending external IP address retrieval operations. This correlation and state management enables the external IP address controller (1110) to avoid redundant signaling towards the session managing node (118) and to provide consistent responses to multiple service consumer nodes (114) requesting the external IP address for the same PDU session.

Further, unlike to existing system, the external IP address controller (1110) may support both immediate and deferred retrieval of the external IP address. For instance, when the first service request targets a future PDU session, the external IP address controller (1110) can register, via the Nsmf_EventExposure API, for notification of an event indicating establishment of the PDU session and allocation of the external IP address by the session managing node (118). In such a case, the external IP address controller (1110) may temporarily store the first service request and, upon receiving the corresponding event notification from the session managing node (118), retrieve the external IP address and generate the first service response including the external IP address of the UE. Conversely, when the first service request targets an ongoing PDU session, the external IP address controller (1110) may request immediate reporting of the external IP address from the session managing node (118) and return the obtained external IP address to the service consumer node (114) without delay.

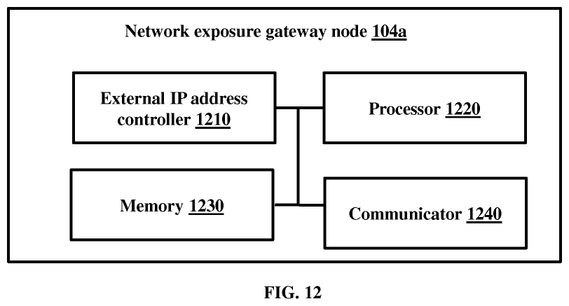

FIG. 12 is a block diagram illustrating a network exposure gateway node (104a) for optimizing retrieval of the external Internet Protocol (IP) address of a User Equipment (UE) in the communication system (1000), according to embodiments as disclosed herein. The network exposure gateway node (104a) can be a Network Exposure Function (NEF) in a 5G network. Further, in a 6G network, the network exposure gateway node (104a) can be any network function configured to expose network services and support retrieval of the external IP address of the UE associated with a session.

The NEF (104a) comprises an external IP address controller (1210), a processor (1220), a memory (1230), and a communicator (1240), which are operatively coupled to each other. In an embodiment, the processor (1220), the memory (1230), the communicator (1240), and the external IP address controller (1210) are interconnected through one or more internal buses, interconnects, or interface circuits for coordinated execution of control, signaling, and data handling operations.

The processor (1220) communicates with the memory (1230), the communicator (1240), and the external IP address controller (1210). The processor (1220) is configured to execute instructions stored in the memory (1230) and to perform processes associated with operation of the NEF (104). In an embodiment, the processor (1220) is configured to control service request processing, exposure of network services, signaling exchange, and external IP address retrieval operations performed in the NEF (104).

The memory (1230) is configured to store instructions to be executed by the processor (1220). In an embodiment, the memory (1230) stores UE-related information, service request information, subscription-related information, external IP address information, and control instructions associated with retrieval of the external IP address of the UE. The memory (1230) can include one or more non-transitory storage media.

The communicator (1240) includes an electronic circuit specific to a standard that enables wired or wireless communication. The communicator (1240) is configured to communicate internally between internal hardware components of the network system and with external devices via one or more networks. In an embodiment, the communicator (1240) is configured to exchange signaling and data with one or more other network functions in the communication system (1000), including the user data managing node (116), the session managing node (118), and the NAT information exposing node (120).

The external IP address controller (1210) is implemented as dedicated hardware circuitry operatively coupled to the processor (1220), the memory (1230), and the communicator (1240). In an embodiment, the external IP address controller (1210) comprises one or more cooperating hardware blocks including a request processing circuit, a service exposure control circuit, a session information handling circuit, a state management circuit, a message generation and routing circuit, and an interface control circuit. The request processing circuit is configured to receive and parse a request associated with retrieval of the external IP address of the UE. The service exposure control circuit is configured to control exposure of a network service associated with retrieval of the external IP address of the UE. The session information handling circuit is configured to identify session-related information associated with the UE and control signaling exchange with one or more other network functions for retrieval of the external IP address. The state management circuit is configured to maintain service state information and processing state information associated with retrieval of the external IP address. The message generation and routing circuit is configured to generate and route a service request and a service response associated with retrieval of the external IP address of the UE. The interface control circuit is configured to control hardware-level interfacing between the external IP address controller (1210), the processor (1220), the memory (1230), and the communicator (1240).

In an embodiment, the external IP address controller (1210) further comprises dedicated logic circuits, register sets, buffer memory, comparator circuits, control-state registers, and interface buses for hardware-level control of request parsing, service exposure control, session information handling, signaling exchange, state maintenance, and response generation. In an embodiment, the external IP address controller (1210) is configured as a structurally integrated control block within the NEF (104) to perform external IP address retrieval and related signaling control for the UE. Such structural implementation enables the NEF (104) to perform technical control and signaling operations associated with retrieval and provision of the external IP address of the UE.

The external IP address controller (1210) is implemented by dedicated processing circuitry such as logic gates, integrated circuits, microprocessors, microcontrollers, memory circuits, passive electronic components, active electronic components, optical components, hardwired circuits, or the like. The circuits may, for example, be embodied in one or more semiconductors.

The external IP address controller (1210) receives from the AF node (106) the first service request for retrieval of the external IP address of the one or more UEs targeting one of an ongoing and a future Protocol Data Unit (PDU) session. In an embodiment, the first service request uses Nnef_UeAddress_Get service operation when a network exposing gateway node receives a request for the retrieval of the external IP address of an ongoing PDU session of a UE. In another embodiment, the first service request uses Nnef_UeAddress_Subscribe service operation when a network exposing node receives a request for retrieval of the external IP address of the PDU session of a UE of the one or more UEs targeting one of an ongoing and a future PDU session. The first service request includes the first plurality of attributes. The first plurality of attributes includes the GPSI of the one or more UEs, the AF identifier, the IP address of the remote end, and the indicator requesting for the external IP address of the PDU session of the UE of the one or more UEs. Further, the external IP address controller (1210) sends to the AF node (106) a first service response comprising one of the service response comprising the external IP address of the UE and an error response when the external IP address of the UE cannot be retrieved.

In an embodiment, the external IP address controller (1210) determines the session managing node (118) providing the external IP address of the UE when handling the PDU session established for the UE. Further, the external IP address controller (1210) sends to the session managing node (118) a second service request for retrieval of the external IP address of the PDU session of the UE. The second service request uses Nsmf_EventExposure API in 5G network. The second service request includes a second plurality of attributes. The second plurality of attributes includes the SUPI, the PDU session identifier, the IP address of a remote end, and at least one of an indicator and an event requesting for the external IP address of the UE. Further, the external IP address controller (1210) receives the second service response from the session managing node (118).

In an embodiment, the external IP address controller (1210) receives from a session managing node (118) a second service response including one of the external IP address of the PDU session of the UE and an error response when the external IP address of the UE cannot be retrieved. Further, the external IP address controller (1210) generates by the network exposure gateway node (104a) the first response comprising the external IP address of the UE and generates by the network exposure gateway node (104a) the first response comprising the error response.

In an embodiment, the external IP address controller (1210) determines that the first service request is for one of ongoing and future PDU sessions of one or more UEs. Further, the external IP address controller (1210) sends to the user data managing node (116) the third service request for retrieval of the external IP address of the one or more UEs. The third service request uses Nudm_EventExposure API in 5G network. The third service request includes a third plurality of attributes. The third plurality of attributes comprises DNN, at least one of a GPSI and a SUPI, an IP address of a remote end, DNN slice identifier, and at least one of an indicator and an event requesting for the external IP address of the PDU session of a UE of the one or more UEs. Further, the external IP address controller (1210) receives from the user data managing node (116) the third service response including one of the external IP address of the PDU session of the UE and an error response when the external IP address of the UE cannot be retrieved, and the external IP address controller (1210) generates by the network exposure gateway node (104a) the first response comprising the external IP address of the UE and generates by the network exposure gateway node (104a) the first response comprising the error response.

Unlike the existing system, when the first service request corresponds to a subscription-type operation, such as the Nnef_UeAddress_Subscribe service operation, the external IP address controller (1210) may establish and maintain a subscription context associated with the one or more UEs and the corresponding PDU sessions. The subscription context may include, for example, the GPSI or SUPI, the AF identifier, the DNN and slice identifier, the remote end IP address, and the specific event or indicator defining the conditions under which the external IP address information is to be reported (for example, upon PDU session establishment, modification, or release). The external IP address controller (1210) may store this subscription context in a local database and, based on the subscription, may further subscribe to corresponding event exposure services at the session managing node (118) via the Nsmf_EventExposure API and/or at the user data managing node (116) via the Nudm_EventExposure API. When the subscribed event occurs, the external IP address controller (1210) may receive updated external IP address information and may trigger the generation of one or more subsequent first service responses toward the AF node (106), thereby enabling near real-time exposure of external IP address changes for ongoing and future PDU sessions.

The external IP address controller (1210) may support correlation and aggregation of responses when the first service request relates to multiple UEs and/or multiple PDU sessions. For example, when the first service request includes a GPSI that maps to a group of UEs or a plurality of PDU sessions, the external IP address controller (1210) may issue multiple second and/or third service requests toward different session managing nodes (118) and user data managing nodes (116). The external IP address controller (1210) may then correlate the received second and third service responses based on identifiers such as SUPI, PDU session identifier, DNN, and slice identifier, and may construct a consolidated first service response that includes the external IP address information, or corresponding error indications, for each UE or PDU session covered by the original request. In some implementations, the external IP address controller (1210) may also apply filtering or prioritization rules, for example, returning only external IP addresses associated with PDU sessions matching a specific DNN or slice identifier, or omitting entries for which the external IP address retrieval failed, depending on the service requirements indicated in the first plurality of attributes.

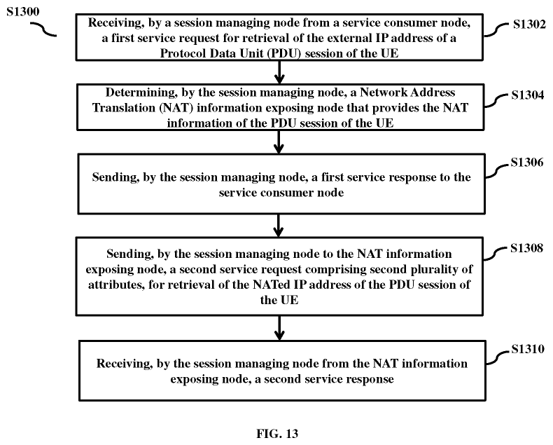

FIG. 13 is a flow chart (S1300) illustrating a method implemented by the session managing node (118) for optimizing retrieval of the external IP address of the UE in the communication system (1000), according to embodiments as disclosed herein. The operations (S1302-S1310) are handled by the external IP address controller (1010).

At S1302, the method includes receiving, from the service consumer node (114), the first service request for retrieval of the external IP address of the PDU session of the UE. The first service request includes an identifier of the UE and a first plurality of attributes. The first plurality of attributes includes a SUPI, a PDU session identifier, an IP address of a remote end, and at least one of an indicator and an event ID requesting the external IP address of the UE. At S1304, the method further includes determining the NAT information exposing node (120) that provides the NAT information of the PDU session of the UE.

At S1306, the method includes sending the first service response to the service consumer node (114). In an embodiment, the first service response is the response comprising the external IP address of the PDU session of the UE when NAT exposure is supported by the NAT information exposing node (120) for the PDU session of the UE. The external IP address includes one of: (i) a NATed IP address of the PDU session of the UE received from the NAT information exposing node, and (ii) a private IP address of the PDU session of the UE when an error was received from the NAT information exposing node. In another embodiment, the first service response is an error response indicating that the external IP address of the PDU session of the UE cannot be retrieved when NAT exposure is not supported by any NAT information exposing node (120) for the PDU session of the UE.

At step 1308, the method includes sending, by the session managing node (118) to the NAT information exposing node, a second service request comprising the second plurality of attributes, for retrieval of the NATed IP address of the PDU session of the UE. The second plurality of attributes includes the private IP address of the UE, the IP address of the remote end, the indicator for immediate reporting and an event ID indicating the request for the NATed IP address of the PDU session of the UE, At step 1310, the method includes receiving, by the session managing node (118) from the NAT information exposing node, the second service response. The second service response comprises a response comprising the NATed IP address of the PDU session of the UE when NATing is enabled for the PDU session of the UE and generating, by the session managing node (118), the first service response comprising the NATed IP address of the PDU session of the UE to the service consumer node (114). In another embodiment, the second service response comprises the error response when NATing is not enabled for the PDU session of the UE and generating, by the session managing node (118), the first service response comprising the private IP address of the PDU session of the UE to the service consumer node (114).

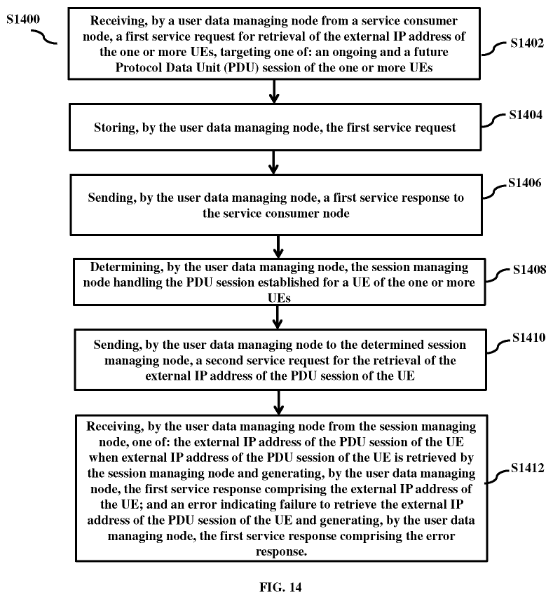

FIG. 14 is a flow chart (S1400) illustrating a method implemented by the user data managing node (116) for optimizing retrieval of the IP address of the UE in the communication system (1000), according to embodiments as disclosed herein. The operations (S1402-S1412) are handled by the external IP address controller (1110). At S1402, the method includes receiving, from the service consumer node (114), the first service request for retrieval of the external IP address of the one or more UEs targeting one of an ongoing and a future PDU session of the one or more UEs. The first service request includes a first plurality of attributes. The first plurality of attributes includes at least one of the GPSI, the SUPI, Data Network Name (DNN), an IP address of a remote end, and at least one of an event and an indicator requesting the external IP address of the PDU session of a UE of the one or more UEs. At S1404, the method includes storing the first service request. At S1406, the method includes sending the first service response to the service consumer node (114). The first service response includes one of an error response and a service response comprising the external IP address of the UE.

At S1408, the method includes determining, by the user data managing node (116), the session managing node (118) handling the PDU session established for a UE of the one or more UEs. At S1410, the method includes sending, by the user data managing node (116) to the determined session managing node (118), a second service request for the retrieval of the external IP address of the PDU session of the UE. The second service request comprises the second plurality of attributes. The second plurality of attributes includes of a SUPI, a PDU session identifier, the IP address of a remote end, and at least one of event and an indicator requesting for the external IP address of the PDU session of the UE.

At S1412, the method includes receiving, by the user data managing node (116) from the session managing node (118), one of: a) the external IP address of the PDU session of the UE when external IP address of the PDU session of the UE is retrieved by the session managing node (118) and generating, by the user data managing node (116), the first service response comprising the external IP address of the UE; and b) an error indicating failure to retrieve the external IP address of the PDU session of the UE and generating, by the user data managing node (116), the first service response comprising the error response.

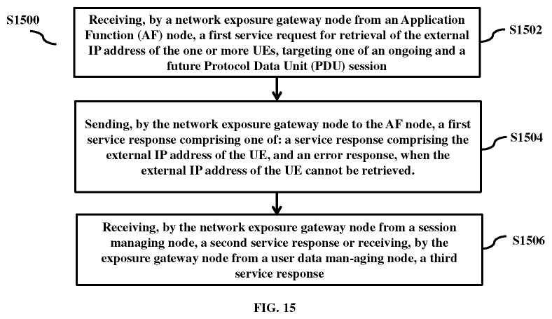

FIG. 15 is a flow chart (S1500) illustrating a method implemented by the network exposure gateway node (104a) for optimizing retrieval of the IP address of the UE in the communication system (1000), according to embodiments as disclosed herein. The operations (S1502-S1506) are handled by the external IP address controller (1210). At S1502, the method includes receiving, from the AF node (106), the first service request for retrieval of the external IP address of the one or more UEs targeting one of an ongoing and a future PDU session. The first service request includes the first plurality of attributes. The first plurality of attributes includes a GPSI of the one or more UEs, the AF identifier, the IP address of a remote end, and the indicator requesting the external IP address of the PDU session of a UE of the one or more UEs. At S1504, the method includes sending, by the network exposure gateway node (104a) to the AF node (106), the first service response comprising one of a service response comprising the external IP address of the UE and an error response when the external IP address of the UE cannot be retrieved.

At step S1506, the method includes receiving, by the network exposure gateway node (104a) from a session managing node (118), a second service response comprising one of: a) the external IP address of the PDU session of the UE and generating, by the network exposure gateway node (104a), the first response comprising the external IP address of the UE; and b) an error response, when the external IP address of the UE cannot be retrieved, and generating, by the network exposure gateway node (104a), the first response comprising the error response.

In an embodiment, the receiving the second service response, from the session managing node (118) includes determining, by the network exposure gateway node (104a), the session managing node (118) providing the external IP address of the UE, when handling the PDU session established for the UE; sending, by the network exposure gateway node (104a) to the session managing node (118), a second service request for retrieval of the external IP address of the PDU session of the UE, wherein the second service request comprises second plurality of attributes, wherein the second plurality of attributes comprises of a Subscription Permanent Identifier (SUPI), a PDU session identifier, the IP address of a remote end, and at least one of an indicator and an event requesting for the external IP address of the UE; and receiving the second service response from the session managing node (118).

Alternatively, the method includes receiving, by the exposure gateway node from the user data managing node (116), a third service response comprising one of: a) the external IP address of the PDU session of the UE and generating, by the network exposure gateway node (104a), the first response comprising the external IP address of the UE, and b) an error response, when the external IP address of the UE cannot be retrieved, and generating, by the network exposure gateway node (104a), the first response comprising the error response.

In an embodiment, receiving the third service response from the user data managing node (116) includes determining, by the network exposure gateway node (104a), that the first service request is for one of ongoing and future PDU sessions of one or more UEs; sending, by the network exposure gateway node (104a) to the user data managing node (116), a third service request, for retrieval of the external IP address of the one or more UEs, wherein the third service request comprises a third plurality of attributes, wherein the third plurality of attributes comprises DNN, at least one of a GPSI and a SUPI, an IP address of a remote end, Data Network Name (DNN), slice identifier and at least one of an indicator and an event requesting for the external IP address of the PDU session of a UE of the one or more UEs; and receiving the third service response from the user data managing node (116).

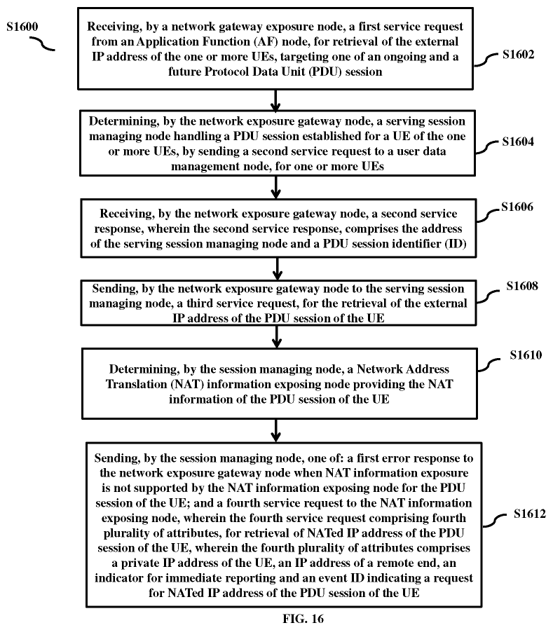

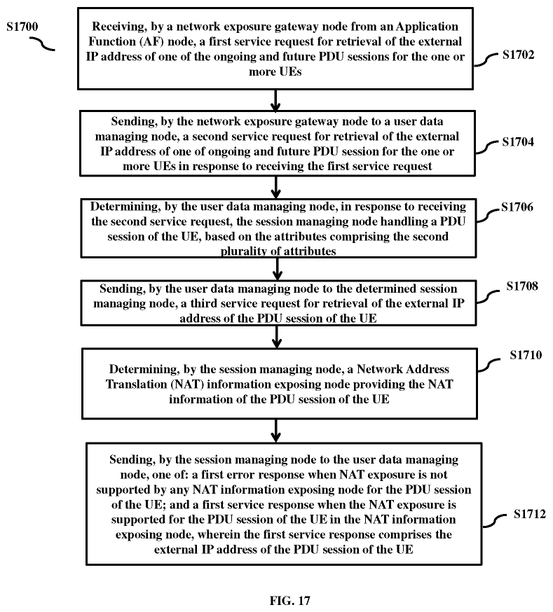

FIG. 16 and FIG. 17 are illustrating overall processes (S1600 and S1700) of a method for optimizing retrieval of the IP address of the UE in the communication system (1000), according to embodiments as disclosed herein.

As shown in FIG. 16, at S1602, the method includes receiving, by the network gateway exposure node, the first service request from the AF node (106), for retrieval of the external IP address of the one or more UEs, targeting one of an ongoing and the future PDU session. The first service request includes the first plurality of attributes. The first plurality of attributes includes the GPSI of one or more UEs, the AF identifier, the IP address of the remote end and the indicator requesting the external IP address of the PDU session of the UE of the one or more UEs. at S1604, the method includes determining, by the network exposure gateway node (104a), the serving session managing node (118) handling a PDU session established for a UE of the one or more UEs, by sending a second service request to a user data management node, for one or more UEs. The second service request includes the second plurality of attributes. The second plurality of attributes includes at least one of the GPSI and a SUPI of one or more UEs, an IP address of the remote end, DNN, slice identifier and at least one of an indicator and event requesting for the external IP address of the PDU session of a UE of the one or more UEs.

At S1606, the method includes receiving, by the network exposure gateway node (104a), the second service response, where the second service response, includes the address of the serving session managing node (118) and a PDU session ID. At S1608, the method includes sending, by the network exposure gateway node (104a) to the serving session managing node (118), the third service request, for the retrieval of the external IP address of the PDU session of the UE. The third service request includes a third plurality of attributes, where the third plurality of attributes includes the IP address of the remote end, a Subscription Permanent Identifier (SUPI), a PDU session ID, and at least one of an indicator and event ID requesting for the external IP address of the PDU session of the UE.

At S1610, the method includes determining, by the session managing node (118), the NAT information exposing node (120) providing the NAT information of the PDU session of the UE. At S1602, the method includes sending, by the session managing node (118), one of: a first error response to the network exposure gateway node (104a) when NAT information exposure is not supported by the NAT information exposing node (120) for the PDU session of the UE; and a fourth service request to the NAT information exposing node. The fourth service request including fourth plurality of attributes, for retrieval of NATed IP address of the PDU session of the UE. The fourth plurality of attributes includes a private IP address of the UE, an IP address of a remote end, an indicator for immediate reporting and an event ID indicating a request for NATed IP address of the PDU session of the UE.

As shown in FIG. 17, at S1702, the method includes receiving, by the network exposure gateway node (104a) from the AF node (106), the first service request for retrieval of the external IP address of one of the ongoing and future PDU sessions for the one or more UEs. The first service request includes first plurality of attributes. The first plurality of attributes includes the GPSI for the one or more UEs, the AF ID, the IP address of the remote end, and an indicator requesting for the external IP address of the PDU session of the UE of the one or more UEs.

At S1704, the method includes sending, by the network exposure gateway node (104a) to the user data managing node (116), the second service request for retrieval of the external IP address of one of ongoing and future PDU session for the one or more UEs in response to receiving the first service request. The second service request includes the second plurality of attributes, where the second plurality of attributes includes at least one of the GPSI and a SUPI of one or more UEs, the DNN, the slice identifier, the IP address of the remote end, and the at least one of an event and the indicator requesting for the external IP address of the PDU session of the UE of the one or more UEs.

At S1706, the method includes determining, by the user data managing node (116), in response to receiving the second service request, the session managing node (118) handling a PDU session of the UE, based on the attributes including the second plurality of attributes. At S1708, the method includes sending, by the user data managing node (116) to the determined session managing node (118), the third service request for retrieval of the external IP address of the PDU session of the UE. The third service request includes a third plurality of attributes, where the third plurality of attributes includes the SUPI, a PDU session ID, the IP address of the remote end, and at least one of an indicator and event ID requesting for the external IP address of the UE.

At S1710, the method includes determining, by the session managing node (118), the NAT information exposing node (120) providing the NAT information of the PDU session of the UE. At S1712, the method includes sending, by the session managing node (118) to the user data managing node (116), one of: a first error response when NAT exposure is not supported by any NAT information exposing node (120) for the PDU session of the UE; and a first service response when the NAT exposure is supported for the PDU session of the UE in the NAT information exposing node. The first service response includes the external IP address of the PDU session of the UE. The external IP address includes one of: a) NATed IP address of the PDU session of the UE when NATed IP address of the PDU session of the UE was received from the NAT information exposing node (120) when NAT is enabled for the PDU session of the UE; and b) private IP address of the PDU session of the UE when an error was received from the NAT information exposing node (120) indicating that NAT is not enabled for the requested PDU session of the UE.

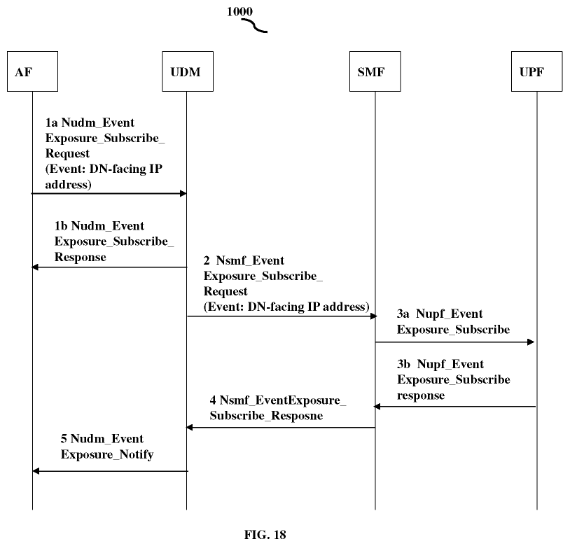

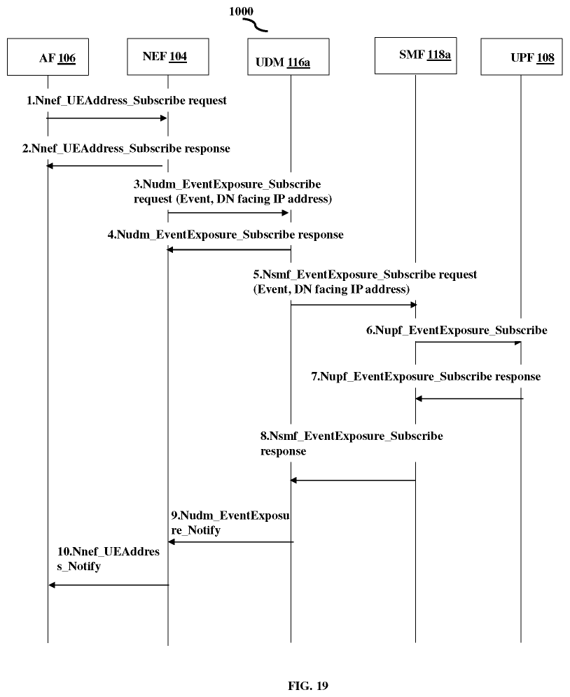

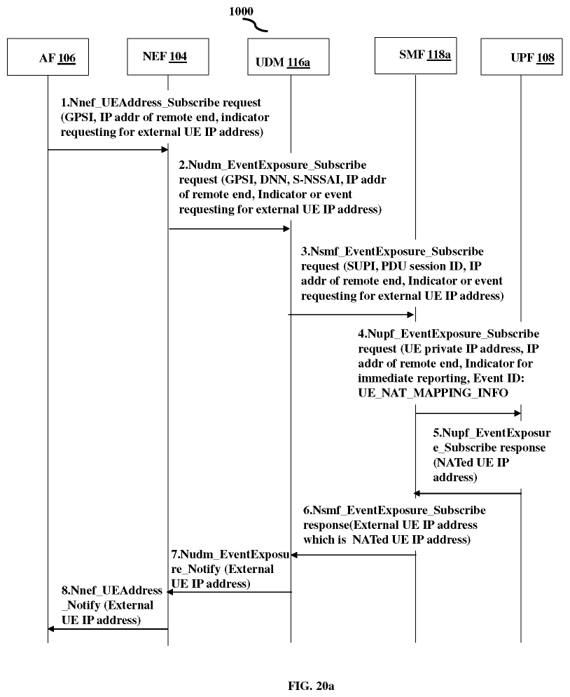

FIG. 18 is an example sequence diagram illustrating an updated procedure for providing DN-facing UE IP address ( ) to the AF that can interact directly with the NFs according to embodiments as disclosed herein. The DN-facing UE IP address is an external IP address of the UE.

The UDM (116a) is the central entity having information about PDU details of the UE such as PDU session ID, DNN, S-NSSAI, serving SMF address provided during the PDU session establishment procedure. With this information, UDM (116a) can invoke the subsequent service of the serving SMF (118a). So, it is proposed to choose UDM (116a) as the interface NF in the service chain. To support this chaining, a new event for obtaining the DN-facing UE IP address is proposed in the Nudm_EventExposure service. When the service is invoked for this new event, the UDM (116a) contacts the serving SMF (118a) for DN-facing UE IP address whenever the PDU session is established for that UE identified by the parameters such as UE ID, DNN, S-NSSAI provided in the subscription. By using this service, a subscription can also be created for a group of UEs and for future PDU session(s).

The SMF (118a) determines the serving UPF (108) for the established PDU session. To enable SMF (118a) to contact the serving UPF (108) to get the DN-facing IP address, a new event is proposed within Nsmf_EventExposure service. The request will have parameters such as PDU session ID, UE ID, DNN, S-NSSAI associated with the event. When the service is invoked for the event, the SMF (118a) will determine if NAT exposure is enabled in the serving UPF (108). Based on the NAT exposure status of the UPF (108), the following steps are taken by the SMF (118a):
a) If NAT exposure is enabled, the SMF (118a) will interact with the serving UPF (108) by invoking the Nupf_EventExposure service for the event UE_NAT_MAPPING_INFO. In response,
   i. if the NAT is enabled, then UPF (108) will send the NATed UE IP address in the UeNatMappingInfo, an attribute used to convey NATed UE IP address. The SMF (118a) will respond to the UDM (116a) with the NATed UE IP address, which is the DN-facing UE IP address.
   ii. if the NAT is not enabled, the UPF (108) will send an empty UeNatMappingInfo. Upon receiving an empty UeNatMappingInfo, the SMF (118a) infers that NAT is not enabled in UPF (108) and subsequently sends the private UE IP address as the DN-facing UE IP address to the UDM (116a).
b) If NAT exposure is not enabled in UPF (108), the SMF (118a) will send a failure message to the UDM (116a). The SMF (118a) can optionally send the private UE IP address with the indication that private UE IP address is being sent.

As shown in FIG. 18, the steps involved in the proposed procedure are described below.

In Step 0, the AF (106) receives a request from the NWDAF (102) for UE application data, with the NWDAF (102) providing inputs such as SUPI, DNN, and S-NSSAI. In Step 1, the AF (106) interacts with the UDM (116a) to create a subscription for the DN-facing IP address by invoking the proposed DN-facing IP address event in the Nudm_EventExposure_Subscribe service. The subscription request includes the input parameters SUPI, DNN, and S-NSSAI.

In Step 2, when the PDU session is established, the UDM (116a) requests the serving SMF to provide the DN-facing IP address by invoking the proposed DN-facing UE IP address event in the Nsmf_EventExposure_Subscribe service. The request includes input parameters such as PDU session ID, SUPI, DNN, and S-NSSAI.

In Step 3a, if NAT exposure is enabled in the serving UPF (108), the SMF (118a) requests the serving UPF (108) to provide the NATed UE IP address by invoking the Nupf_EventExposure service for the event UE_NAT_MAPPING_INFO. However, if NAT exposure is not supported by the UPF (108), then the SMF (118a) sends a failure message with the UE private IP address and an indication that the UE private IP address is being sent to the UDM (116a).

In Step 3b, in response, if the NAT is enabled, then the UPF (108) sends the public UE IP address, which is the DN-facing UE IP address, in the UeNatMappingInfo, an attribute used to convey the public UE IP address. If the NAT is not enabled, the UPF (108) sends an empty UeNatMappingInfo.

In Step 4, upon receipt of the UeNatMappingInfo, the SMF (118a) responds to the UDM (116a) with the DN-facing UE IP address, which is the NATed UE IP address if a non-empty UeNatMappingInfo attribute is received from the UPF (108), and the private UE IP address if an empty UeNatMappingInfo attribute is received from the UPF (108).

In Step 5, subsequently, the UDM (116a) notifies the DN-facing IP address to the AF.

The benefits of this approach are listed below. The AF (106) can obtain the DN-facing UE IP address by interacting with just the UDM (116a) instead of multiple NFs, thus simplifying its processing. In a single request, the AF (106) can also subscribe to DN-facing UE IP addresses corresponding to a group of UEs. Furthermore, the AF (106) can request UE IP addresses of both ongoing and future PDU session(s).

In case the AF (106) is authorized to interact with the 5G Core only through the NEF, the AF (106) provides a GPSI or external group ID, which represents a group of UEs, in the newly defined attribute in the Nnef_UEAddress_Subscribe service operation. The NEF (104) then invokes the proposed DN-facing UE IP address event in the Nudm_EventExposure service. The subsequent steps in the procedure from UDM (116a) to UPF (108) are similar to the steps followed by the AF (106) that interacts directly with the NFs. When the UDM (116a) sends the notification to the NEF (104) with the DN-facing IP address, the NEF (104) notifies the AF.

FIG. 19 an example sequence diagram illustrating an updated procedure for delivering DN-facing IP address to the AF (106) interacting with the NFs via the NEF, according to embodiments as disclosed herein.

At step 1, the AF 106 sends a Nnef_UEAddress_Subscribe request to the NEF (104). At step 2, the NEF (104) sends a Nnef_UEAddress_Subscribe response to the AF (106). At step 3, the NEF (104) sends the Nudm_EventExposure_Subscribe request (including Event, and DN facing IP address) to the UDM 116a. At step 4, the UDM 116a sends the Nudm_EventExposure_Subscribe response to the NEF (104). At step 5, the UDM 116a sends the Nsmf_EventExposure_Subscribe request (including the event, and the DN facing IP address) to the SMF 118a. At step 6, the SMF 118a sends a Nupf_EventExposure_Subscribe to the UPF 108. At step 7, the UPF 108 sends the Nupf_EventExposure_Subscribe response to the SMF 118a. At step 8, the SMF 118a sends the Nsmf_EventExposure_Subscribe response to the UDM 116a. At step 9, the UDM 116a sends the Nudm_EventExposure_Notify to the NEF (104). At step 10, the NEF (104) sends the Nnef_UEAddress_Notify to the AF 106.

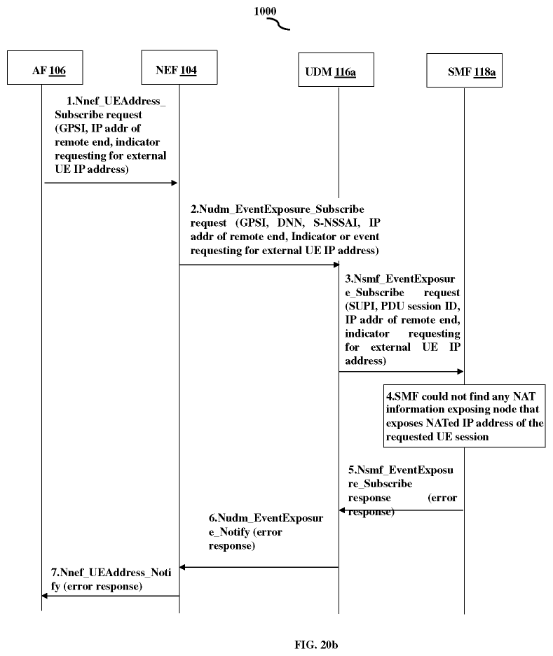

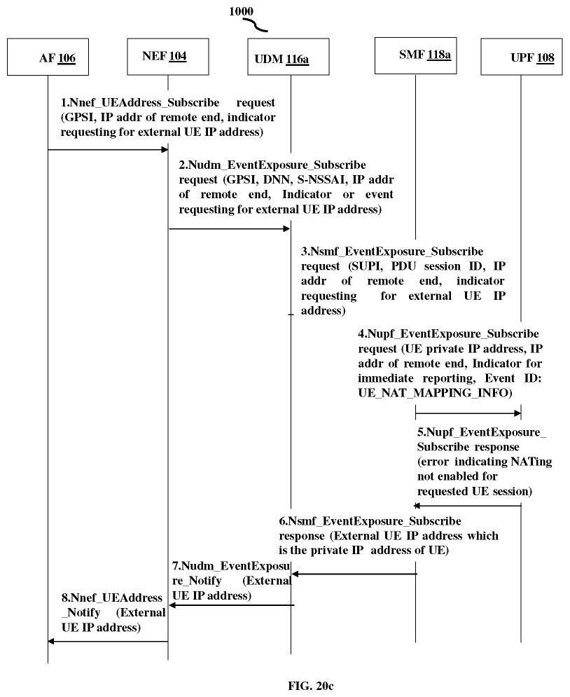

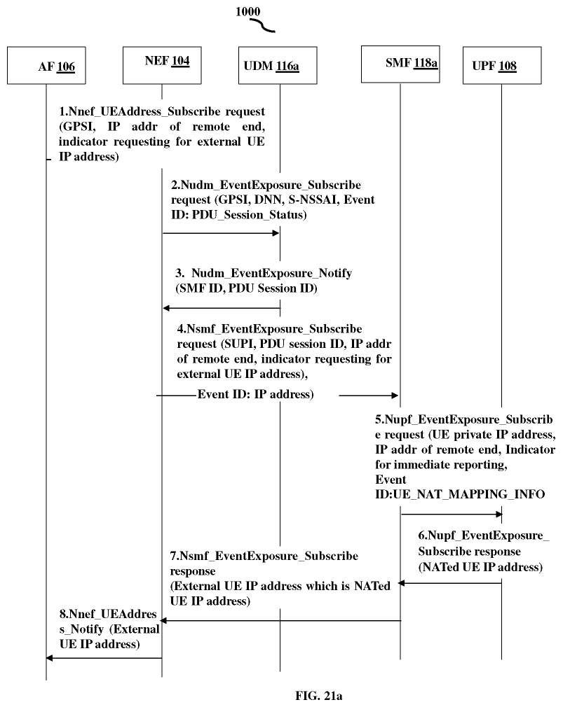

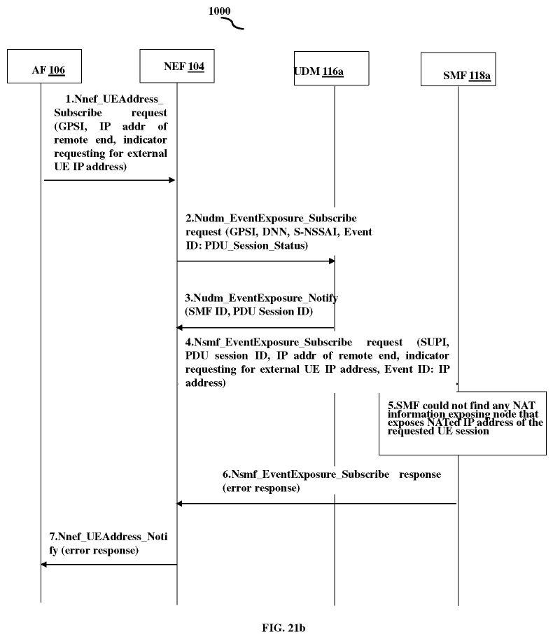

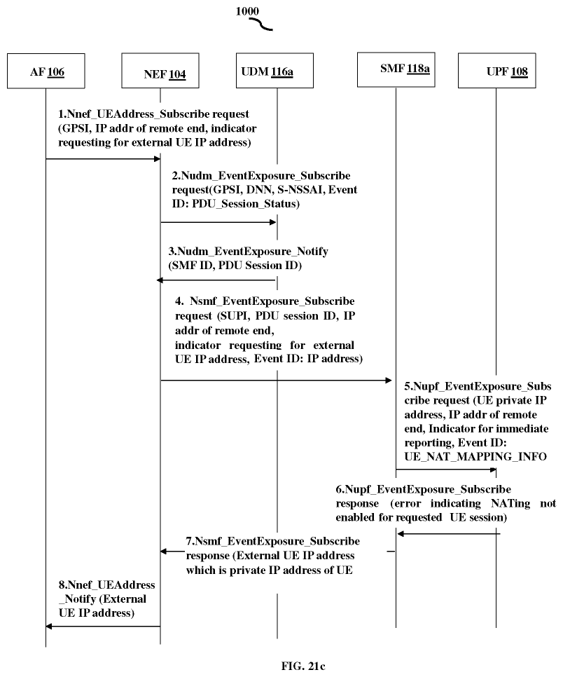

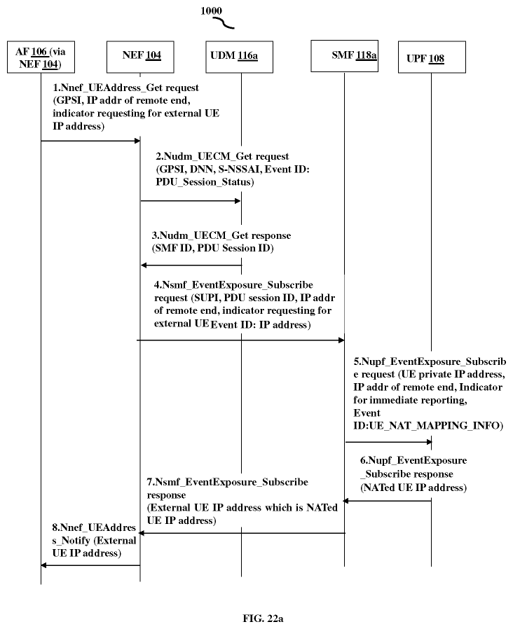

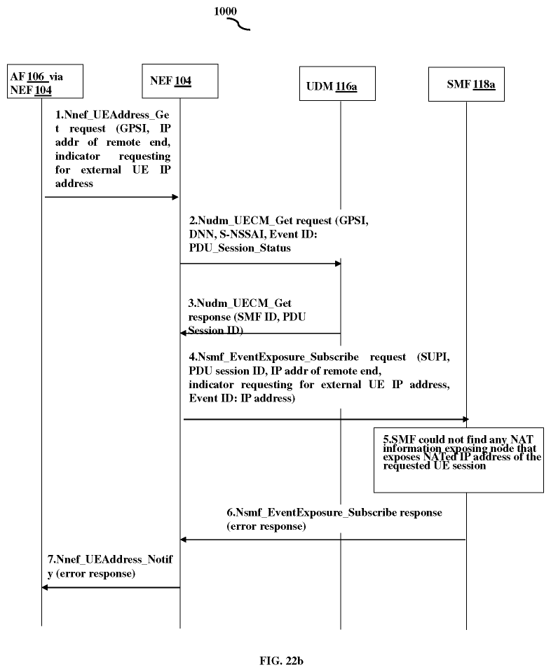

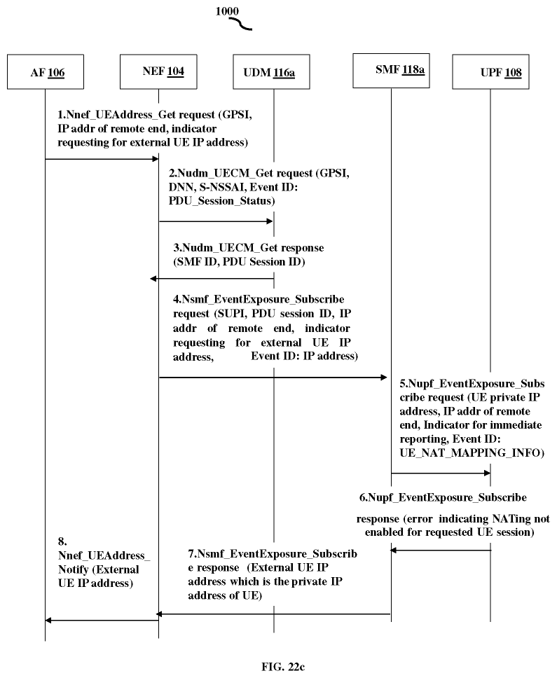

FIG. 20A to FIG. 22C are example sequence diagrams illustrating a step-by-step process for optimizing retrieval of the IP address of the UE in the communication system (1000), according to embodiments as disclosed herein.

As shown in FIG. 20a, At step 1, the AF (106) sends an Nnef_UEAddress_Subscribe request (including GPSI, IP addr of remote end indicator requesting for external UE IP address) to the NEF (104). At step 2, the NEF (104) sends a Nudm_EventExposure_Subscribe request (including GPSI, DNN, S-NSSAI, IP addr of remote end indicator or event requesting for external UE IP address) to the UDM (116a). At step 3, the UDM (116a) sends an Nsmf_EventExposure_Subscribe request (including SUPI, PDU session ID, IP addr of remote end indicator or event requesting for external UE IP address) to the SMF (118a).

Proceeding to step 4, the SMF (118a) sends an Nupf_EventExposure_Subscribe request (including UE private IP address, IP addr of remote end indicator for immediate reporting, Event ID UE_NAT_MAPPING_INFO) to the UPF (108). At step 5, the UPF (108) sends an Nupf_EventExposure_Subscribe response (including NATed UE IP address) to the SMF (118a). At step 6, the SMF (118a) sends an Nsmf_EventExposure_Subscribe response (including the external UE IP address which is the NATed UE IP address) to the UDM (116a). At step 7, the UDM (116a) sends a Nudm_EventExposure_Notify (including the external UE IP address) to the NEF (104). At step 8, the NEF (104) sends an Nnef_UEAddress_Notify (including external UE IP address) to the AF (106).

In failure case 1, as shown in FIG. 20B, at step 1, the AF (106) sends an Nnef_UEAddress_Subscribe request (including GPSI, IP addr of remote end indicator requesting for external UE IP address) to the NEF (104). 2, the NEF At step (104) sends a Nudm_EventExposure_Subscribe request (including GPSI, DNN, S-NSSAI, IP addr of remote end indicator or event requesting for external UE IP address) to the UDM (116a). At step 3, the UDM (116a) sends an Nsmf_EventExposure_Subscribe request (including SUPI, PDU session ID, IP addr of remote end indicator requesting for external UE IP address) to the SMF (118a).

At step 4, the SMF (118a) cannot find any NAT information exposing node (120) that exposes NATed IP address of the requested UE session. At step 5, the SMF (118a) sends an Nsmf_EventExposure_Subscribe response (including error response) to the UDM (116a). At step 6, the UDM (116a) sends a Nudm_EventExposure_Notify (including error response) to the NEF (104). At step 7, the NEF (104) sends an Nnef_UEAddress_Notify (including error response) to the AF (106).

In failure case 2, as shown in FIG. 20C, at step 1, the AF (106) sends an Nnef_UEAddress_Subscribe request (including GPSI, IP addr of remote end indicator requesting for external UE IP address) to the NEF (104). At step (104) sends a 2, the NEF Nudm_EventExposure_Subscribe request (including GPSI, DNN, S-NSSAI, IP addr of remote end indicator or event requesting for external UE IP address) to the UDM (116a). At step 3, the UDM (116a) sends an Nsmf_EventExposure_Subscribe request (including SUPI, PDU session ID, IP addr of remote end indicator requesting for external UE IP address) to the SMF (118a).

At step 4, the SMF (118a) sends an Nupf_EventExposure_Subscribe request (including UE private IP address, IP addr of remote end indicator for immediate reporting, Event ID UE_NAT_MAPPING_INFO) to the UPF (108). At step 5, the UPF (108) sends an Nupf_EventExposure_Subscribe response (including error indicating NATing not enabled for requested UE session) to the SMF (118a). At step 6, the SMF (118a) sends an Nsmf_EventExposure_Subscribe response (including external UE IP address which is the private IP address of UE) to the UDM (116a). At step 7, the UDM (116a) sends a Nudm_EventExposure_Notify (including external UE IP address) to the NEF (104). At step 8, the NEF (104) sends an Nnef_UEAddress_Notify (including external UE IP address) to the AF (106).

As shown in FIG. 21a, at step 1 the AF (106) sends an Nnef_UEAddress_Subscribe request (including GPSI, IP addr of remote end, and an indicator requesting for external UE IP address) to the NEF (104). At step 2 the NEF (104) sends a Nudm_EventExposure_Subscribe request (including GPSI, DNN, S-NSSAI, Event ID, and PDU_Session_Status) to the UDM (116a). At step 3 the UDM (116a) sends a Nudm_EventExposure_Notify (including SMF ID and PDU Session ID) to the NEF (104). At step 4 the NEF (104) sends an Nsmf_EventExposure_Subscribe request (including SUPI, PDU session ID, IP addr of remote end, an indicator requesting for external UE IP address, Event ID, and IP address) to the SMF (118a).

At step 5 the SMF (118a) sends an Nupf_EventExposure_Subscribe request (including UE private IP address, IP addr of remote end, an Indicator for immediate reporting, Event ID, and UE_NAT_MAPPING_INFO) to the UPF (108). At step 6 the UPF (108) sends an Nupf_EventExposure_Subscribe response (including NATed UE IP address) to the SMF (118a). At step 7 the SMF (118a) sends an Nsmf_EventExposure_Subscribe response (including External UE IP address, which is the NATed UE IP address) to the NEF (104). At step 8 the NEF (104) sends an Nnef_UEAddress_Notify (including External UE IP address) to the AF (106).

In failure case 1, as shown in FIG. 21b, at step 1 the AF (106) sends an Nnef_UEAddress_Subscribe request (including GPSI, IP addr of remote end, and an indicator requesting for external UE IP address) to the NEF (104). At step 2 the NEF (104) sends a Nudm_EventExposure_Subscribe request (including GPSI, DNN, S-NSSAI, Event ID, and PDU_Session_Status) to the UDM (116a). At step 3 the UDM (116a) sends a Nudm_EventExposure_Notify (including SMF ID and PDU Session ID) to the NEF (104). At step 4 the NEF (104) sends an Nsmf_EventExposure_Subscribe request (including SUPI, PDU session ID, IP addr of remote end, an indicator requesting for external UE IP address, Event ID, and IP address) to the SMF (118a). At step 5 the SMF (118a) cannot find any NAT information exposing node (120) that exposes a NATed IP address of the requested UE session. At step 6 the SMF (118a) sends an Nsmf_EventExposure_Subscribe response (including an error response) to the NEF (104). At step 7 the NEF (104) sends an Nnef_UEAddress_Notify (including the error response) to the AF (106).

In failure case 2, as shown in FIG. 21c, at step 1 the AF (106) sends an Nnef_UEAddress_Subscribe request (including GPSI, IP addr of remote end, and an indicator requesting for external UE IP address) to the NEF (104). At 2 NEF step the (104) sends a Nudm_EventExposure_Subscribe request (including GPSI, DNN, S-NSSAI, Event ID, and PDU_Session_Status) to the UDM (116a). At step 3 the UDM (116a) sends a Nudm_EventExposure_Notify (including SMF ID and PDU Session ID) to the NEF (104). At step 4 the NEF (104) sends an Nsmf_EventExposure_Subscribe request (including SUPI, PDU session ID, IP addr of remote end, an indicator requesting for external UE IP address, Event ID, and IP address) to the SMF (118a). At step 5 the SMF (118a) sends an Nupf_EventExposure_Subscribe request (including the UE private IP address, IP addr of remote end, an Indicator for immediate reporting, Event ID, and UE_NAT_MAPPING_INFO) to the UPF (108). At step 6 the UPF (108) sends an Nupf_EventExposure_Subscribe response (including an error indicating NATing not enabled for the requested UE session) to the SMF (118a). At step 7 the SMF (118a) sends an Nsmf_EventExposure_Subscribe response (including External UE IP address, which is the private IP address of the UE) to the NEF (104). At step 8 the NEF (104) sends an Nnef_UEAddress_Notify (including External UE IP address) to the AF (106).

As shown in FIG. 22a, at step 1, the AF (106) sends the Nnef_UEAddress_Get request (including GPSI, IP addr of remote end, and indicator requesting for external UE IP address) to the NEF (104). At step 2, the NEF (104) sends the Nudm_UECM_Get request (including GPSI, DNN, S-NSSAI, Event ID, and PDU_Session_Status) to the UDM (116a). At step 3, the UDM (116a) sends the Nudm_UECM_Get response (including SMF ID and PDU Session ID) to the NEF (104).

At step 4, the NEF (104) sends the Nsmf_EventExposure_Subscribe request (including SUPI, PDU session ID, IP addr of remote end, indicator requesting for external UE IP address, Event ID, and IP address) to the SMF (118a). At step 5, the SMF (118a) sends the Nupf_EventExposure_Subscribe request (including UE private IP address, IP addr of remote end, Indicator for immediate reporting, Event ID, and UE_NAT_MAPPING_INFO) to the UPF (108). At step 6, the UPF (108) sends the Nupf_EventExposure_Subscribe response (including NATed UE IP address) to the SMF (118a).

Next, at step 7, the SMF (118a) sends the Nsmf_EventExposure_Subscribe response (including External UE IP address, which is the NATed UE IP address) to the NEF (104). At step 8, the NEF (104) sends the Nnef_UEAddress_Notify (including External UE IP address) to the AF (106).

In failure case 1, as shown in FIG. 22b, at step 1, the AF (106) sends the Nnef_UEAddress_Get request (including GPSI, IP addr of remote end, and indicator requesting for external UE IP address) to the NEF (104). At step 2, the NEF (104) sends the Nudm_UECM_Get request (including GPSI, DNN, S-NSSAI, Event ID, and PDU_Session_Status) to the UDM (116a). At step 3, the UDM (116a) sends the Nudm_UECM_Get response (including SMF ID and PDU Session ID) to the NEF (104).

Then, at step 4, the NEF (104) sends the Nsmf_EventExposure_Subscribe request (including SUPI, PDU session ID, IP addr of remote end, indicator requesting for external UE IP address, Event ID, and IP address) to the SMF (118a). At step 5, the SMF (118a) could not find any NAT information exposing node (120) that exposes NATed IP address of the requested UE session. At step 6, the SMF (118a) sends the Nsmf_EventExposure_Subscribe response (including error response) to the NEF (104). At step 7, the NEF (104) sends the Nnef_UEAddress_Notify (including error response) to the AF (106).

In failure case 2, as shown in FIG. 22c, at step 1, the AF (106) sends the Nnef_UEAddress_Get request (including GPSI, IP addr of remote end, and indicator requesting for external UE IP address) to the NEF (104). At step 2, the NEF (104) sends the Nudm_UECM_Get request (including GPSI, DNN, S-NSSAI, Event ID, and PDU_Session_Status) to the UDM (116a). At step 3, the UDM (116a) sends the Nudm_UECM_Get response (including SMF ID and PDU Session ID) to the NEF (104).

Subsequently, at step 4, the NEF (104) sends the Nsmf_EventExposure_Subscribe request (including SUPI, PDU session ID, IP addr of remote end, indicator requesting for external UE IP address, and Event ID, IP address) to the SMF (118a). At step 5, the SMF (118a) sends the Nupf_EventExposure_Subscribe request (including UE private IP address, IP addr of remote end, Indicator for immediate reporting, Event ID, and UE_NAT_MAPPING_INFO) to the UPF (108). At step 6, the UPF (108) sends the Nupf_EventExposure_Subscribe response (including error indicating NATing not enabled for requested UE session) to the SMF (118a).

Furthermore, at step 7, the SMF (118a) sends the Nsmf_EventExposure_Subscribe response (including external UE IP address, which is the private IP address of UE) to the NEF (104). At step 8, the NEF (104) sends the Nnef_UEAddress_Notify (including external UE IP address) to the AF (106).

The various actions, acts, blocks, steps, or the like in the flowcharts (S1300-S1700) may be performed in the order presented, in a different order, or simultaneously. Further, in some embodiments, some of the actions, acts, blocks, steps, or the like may be omitted, added, modified, or skipped without departing from the scope of the present disclosure.

The foregoing description of the specific embodiments will so fully reveal the general nature of the embodiments herein that others can, by applying current knowledge, readily modify and/or adapt such specific embodiments for various applications without departing from the generic concept, and therefore such adaptations and modifications are intended to be comprehended within the meaning and range of equivalents of the disclosed embodiments. It is to be understood that the phraseology and terminology employed herein are for the purpose of description and not of limitation. Therefore, while the embodiments herein have been described in terms of preferred embodiments, those skilled in the art will recognize that the embodiments herein can be practiced with modifications within the scope of the embodiments as described herein.

We claim:

1. A method for optimizing retrieval of an external Internet Protocol (IP) address of a User Equipment (UE) in a communication system (1000), comprising:
receiving, by a session managing node (118) from a service consumer node (114), a first service request for retrieval of the external IP address of a Protocol Data Unit (PDU) session of the UE, wherein the first service request comprises an identifier of the UE and first plurality of attributes, wherein the first plurality of attributes comprises a Subscription Permanent Identifier (SUPI), a Protocol Data Unit (PDU) session identifier, an IP address of a remote end, and at least one of an indicator and an event ID requesting for the external IP address of the UE;
determining, by the session managing node (118), a Network Address Translation (NAT) information exposing node that provides the NAT information of the PDU session of the UE; and
sending, by the session managing node (118), a first service response to the service consumer node (114); wherein the first service response is one of:
a) a response comprising the external IP address of the PDU session of the UE, when NAT exposure is supported by the NAT information exposing node (120) for the PDU session of the UE, wherein the external IP address comprises one of:
i) NATed IP address of the PDU session of the UE received from the NAT information exposing node; and
ii) private IP address of the PDU session of the UE when an error was received from the NAT information exposing node;
b) an error response indicating that the external IP address of the PDU session of the UE cannot be retrieved, when NAT exposure is not supported by any NAT information exposing node (120) for the PDU session of the UE.

2. The method as claimed in claim 1, wherein sending the first service response, when the NAT exposure is supported in the NAT information exposing node (120) comprises:
sending, by the session managing node (118) to the NAT information exposing node, a second service request comprising second plurality of attributes, for retrieval of the NATed IP address of the PDU session of the UE, wherein the second plurality of attributes comprises a private IP address of the UE, an IP address of a remote end, an indicator for immediate reporting and an event ID indicating a request for the NATed IP address of the PDU session of the UE; and
receiving, by the session managing node (118) from the NAT information exposing node, a second service response, wherein the second service response comprises one of:
a) a response comprising the NATed IP address of the PDU session of the UE when NATing is enabled for the PDU session of the UE and generating, by the session managing node (118), the first service response comprising the NATed IP address of the PDU session of the UE to the service consumer node (114); and
b) an error response when NATing is not enabled for the PDU session of the UE and generating, by the session managing node (118), the first service response comprising the private IP address of the PDU session of the UE to the service consumer node (114).

3. The method as claimed in claim 2, wherein the first service request is an event exposure subscription request and wherein the first service response is an event exposure notification and wherein the second service request is an event exposure subscription request and wherein the second service response is an event exposure response.

4. The method as claimed in claim 2, wherein the first service request uses Nsmf_EventExposure Application Programming Interface (API) in 5G network, and wherein the second service request uses Nupf_EventExposure API in 5G network.

5. A method for optimizing retrieval of an external Internet Protocol (IP) address of one or more User Equipment's (UEs) in a communication system (1000), comprising:
receiving, by a user data managing node (116) from a service consumer node (114), a first service request for retrieval of the external IP address of the one or more UEs, targeting one of: an ongoing and a future Protocol Data Unit (PDU) session of the one or more UEs, wherein the first service request comprises first plurality of attributes, wherein the first plurality of attributes comprises at least one of a General Public Subscription Identifier (GPSI) and a Subscription Permanent Identifier (SUPI), Data Name Network (DNN), an IP address of a remote end, and at least one of an event and an indicator requesting for the external IP address of the PDU session of a UE of the one or more UEs;
storing, by the user data managing node (116), the first service request; and
sending, by the user data managing node (116), a first service response to the service consumer node (114), wherein the first service response comprises one of:
a) an error response; and
b) a service response comprising the external IP address of the UE.

6. The method as claimed in claim 5, wherein sending the first service response, comprises:
determining, by the user data managing node (116), the session managing node (118) handling the PDU session established for a UE of the one or more UEs;
sending, by the user data managing node (116) to the determined session managing node (118), a second service request for the retrieval of the external IP address of the PDU session of the UE, wherein the second service request comprises a second plurality of attributes, wherein the second plurality of attributes comprises of a SUPI, a PDU session identifier, the IP address of a remote end, and at least one of event and an indicator requesting for the external IP address of the PDU session of the UE; and
receiving, by the user data managing node (116) from the session managing node (118), one of:
a) the external IP address of the PDU session of the UE when external IP address of the PDU session of the UE is retrieved by the session managing node (118) and generating, by the user data managing node (116), the first service response comprising the external IP address of the UE; and
b) an error indicating failure to retrieve the external IP address of the PDU session of the UE and generating, by the user data managing node (116), the first service response comprising the error response.

7. The method as claimed in claim 6, wherein the first service request uses Nudm_EventExposure API in 5G network and wherein the second service request uses Nsmf_EventExposure API in 5G network.

8. A method for optimizing retrieval of an external Internet Protocol (IP) address of one of more User Equipment's (UEs) in a communication system (1000), comprising:
receiving, by a network exposure gateway node (104a) from an Application Function (AF) node, a first service request for retrieval of the external IP address of the one or more UEs, targeting one of an ongoing and a future Protocol Data Unit (PDU) session, wherein the first service request comprises first plurality of attributes, wherein the first plurality of attributes comprises of a General Public Subscription Identifier (GPSI) of the one or more UEs, an AF identifier, an IP address of a remote end, and an indicator requesting for the external IP address of the PDU session of a UE of the one or more UEs; and
sending, by the network exposure gateway node (104a) to the AF node (106), a first service response comprising one of:
a) a service response comprising the external IP address of the UE; and
b) an error response, when the external IP address of the UE cannot be retrieved.

9. The method as claimed in claim 8, wherein sending, the first service response comprises one of:
a) receiving, by the network exposure gateway node (104a) from a session managing node (118), a second service response comprising one of:
i) the external IP address of the PDU session of the UE and generating, by the network exposure gateway node (104a), the first response comprising the external IP address of the UE; and
ii) an error response, when the external IP address of the UE cannot be retrieved, and generating, by the network exposure gateway node (104a), the first response comprising the error response;
b) receiving, by the exposure gateway node from a user data managing node (116), a third service response comprising one of:
i) the external IP address of the PDU session of the UE and generating, by the network exposure gateway node (104a), the first response comprising the external IP address of the UE; and
ii) an error response, when the external IP address of the UE cannot be retrieved, and generating, by the network exposure gateway node (104a), the first response comprising the error response.

10. The method as claimed in claim 9, wherein the receiving the second service response, from the session managing node (118) comprises:
determining, by the network exposure gateway node (104a), the session managing node (118) providing the external IP address of the UE, when handling the PDU session established for the UE;
sending, by the network exposure gateway node (104a) to the session managing node (118), a second service request for retrieval of the external IP address of the PDU session of the UE, wherein the second service request comprises second plurality of attributes, wherein the second plurality of attributes comprises of a Subscription Permanent Identifier (SUPI), a PDU session identifier, the IP address of a remote end, and at least one of an indicator and an event requesting for the external IP address of the UE; and
receiving the second service response from the session managing node (118).

11. The method as claimed in claim 9, wherein receiving the third service response from the user data managing node (116) comprises:
determining, by the network exposure gateway node (104a), that the first service request is for one of ongoing and future PDU sessions of one or more UEs;
sending, by the network exposure gateway node (104a) to the user data managing node (116), a third service request, for retrieval of the external IP address of the one or more UEs, wherein the third service request comprises a third plurality of attributes, wherein the third plurality of attributes comprises DNN, at least one of a GPSI and a SUPI, an IP address of a remote end, Data Network Name (DNN), slice identifier and at least one of an indicator and an event requesting for the external IP address of the PDU session of a UE of the one or more UEs; and
receiving the third service response from the user data managing node (116).

12. The method as claimed in claim 10, wherein the second service request uses Nsmf_EventExposure API in 5G network and wherein the third service request uses Nudm_EventExposure API in 5G network, wherein the first service request uses one of:
Nnef_UeAddress_Get service operation when network exposing gateway node receives a request for the retrieval of the external IP address of an ongoing PDU session of a UE, and
Nnef_UeAddress_Subscribe service operation when network exposing node receives a request for retrieval of the external IP address of the PDU session of a UE of the one or more UEs, targeting one of an ongoing and a future PDU session.

13. A method for optimizing retrieval of an external Internet Protocol (IP) address of one or more User Equipment's (UEs) for an ongoing Protocol Data Unit (PDU) session in a communication system (1000), comprising:
receiving, by a network gateway exposure node, a first service request from an Application Function (AF) node, for retrieval of the external IP address of the one or more UEs, targeting one of an ongoing and a future Protocol Data Unit (PDU) session, wherein the first service request comprises first plurality of attributes, wherein the first plurality of attributes comprises a General Public Subscription Identifier (GPSI) of one or more UEs, an AF identifier, an IP address of a remote end and an indicator requesting the external IP address of the PDU session of a UE of the one or more UEs;
determining, by the network exposure gateway node (104a), a serving session managing node (118) handling a PDU session established for a UE of the one or more UEs, by sending a second service request to a user data management node, for one or more UEs, wherein the second service request comprises a second plurality of attributes, wherein the second plurality of attributes comprises at least one of the GPSI and a SUPI of one or more UEs, an IP address of the remote end, Data Network Name (DNN), slice identifier and at least one of an indicator and event requesting for the external IP address of the PDU session of a UE of the one or more UEs;
receiving, by the network exposure gateway node (104a), a second service response, wherein the second service response, comprises the address of the serving session managing node (118) and a PDU session identifier (ID);
sending, by the network exposure gateway node (104a) to the serving session managing node (118), a third service request, for the retrieval of the external IP address of the PDU session of the UE, wherein the third service request comprises third plurality of attributes, wherein the third plurality of attributes comprises the IP address of the remote end, a Subscription Permanent Identifier (SUPI), a PDU session ID, and at least one of an indicator and event ID requesting for the external IP address of the PDU session of the UE;
determining, by the session managing node (118), a Network Address Translation (NAT) information exposing node providing the NAT information of the PDU session of the UE; and
sending, by the session managing node (118), one of:
a) a first error response to the network exposure gateway node (104a) when NAT information exposure is not supported by the NAT information exposing node (120) for the PDU session of the UE; and
b) a fourth service request to the NAT information exposing node, wherein the fourth service request comprising fourth plurality of attributes, for retrieval of NATed IP address of the PDU session of the UE, wherein the fourth plurality of attributes comprises a private IP address of the UE, an IP address of a remote end, an indicator for immediate reporting and an event ID indicating a request for NATed IP address of the PDU session of the UE.

14. The method as claimed in claim 13, further comprising:
receiving, by the session managing node (118), one of:
a) a fifth service response from the NAT information exposing node, wherein the fifth service response comprises the NATed IP address of the PDU session of the UE when NATing is enabled for the PDU session of the UE; and
b) a second error response from the NAT information exposing node, when NATing is not enabled for the PDU session of the UE.

15. The method as claimed in claim 14, further comprising:
sending, by the session managing node (118) to the network gateway exposure node, one of:
a) the first error response; and
b) a sixth service response, wherein the sixth service response comprises the external IP address of the PDU session of the UE, wherein the external IP address comprises one of:
i) a NATed IP address of the PDU session of the UE when the fifth service response is received; and
ii) a private IP address of the PDU session of the UE when the second error response is received.

16. The method as claimed in claim 15, further comprising:
sending, by the network gateway exposing node to the AF node (106), a seventh service response, wherein the seventh service response comprises one of:
a) a third error response when first error response is received from the session managing node (118); and
b) the external IP address of the UE, when the sixth service response is received from the session managing node (118).

17. The method as claimed in claim 13, wherein the first service request, in 5G network, is one of:
Nnef_UeAddress_Get service operation when network exposing gateway node receives a request for the retrieval of the external IP address of an ongoing PDU session of the UE, and
Nnef_UeAddress_Subscribe service operation when network exposing node receives a request for retrieval of the external IP address of one of an ongoing and a future PDU session of the one or more UEs; and
wherein the second service request, in the 5G network, is one of:
Nudm_UECM_Get service operation when the user data managing node (116) receives a request for the retrieval of the external IP address of an ongoing PDU session of a UE, and
Nudm_EventExposure_Subscribe service operation when the user data managing node (116) receives a request for retrieval of the external IP address of one of an ongoing and a future PDU session of the one or more UEs; and
wherein, the third service request, in the 5G network, uses Nsmf_EventExposure API; and
wherein the fourth service request, in the 5G network, uses Nupf_EventExposure API with EventType set to “UE_NAT_MAPPING_INFO”.

18. A method for optimizing retrieval of an external Internet Protocol (IP) address of one or more User Equipment's (UEs) for one of an ongoing and a future Protocol Data Unit (PDU) session in a communication system (1000), comprising:
receiving, by a network exposure gateway node (104a) from an Application Function (AF) node, a first service request for retrieval of the external IP address of one of the ongoing and future PDU sessions for the one or more UEs, wherein the first service request comprises first plurality of attributes, wherein the first plurality of attributes comprises a General Public Subscription Identifier (GPSI) for the one or more UEs, an AF identifier (ID), an IP address of a remote end, and an indicator requesting for the external IP address of the PDU session of a UE of the one or more UEs;
sending, by the network exposure gateway node (104a) to a user data managing node (116), a second service request for retrieval of the external IP address of one of ongoing and future PDU session for the one or more UEs in response to receiving the first service request, wherein the second service request comprises a second plurality of attributes, wherein the second plurality of attributes comprises at least one of the GPSI and a Subscription Permanent Identifier (SUPI) of one or more UEs, Data Name Network (DNN), slice identifier, an IP address of the remote end, and at least one of an event and an indicator requesting for the external IP address of the PDU session of a UE of the one or more UEs;
determining, by the user data managing node (116), in response to receiving the second service request, the session managing node (118) handling a PDU session of the UE, based on the attributes comprising the second plurality of attributes;
sending, by the user data managing node (116) to the determined session managing node (118), a third service request for retrieval of the external IP address of the PDU session of the UE, wherein the third service request comprises a third plurality of attributes, wherein the third plurality of attributes comprises the SUPI, a PDU session ID, the IP address of the remote end, and at least one of an indicator and event ID requesting for the external IP address of the UE;
determining, by the session managing node (118), a Network Address Translation (NAT) information exposing node providing the NAT information of the PDU session of the UE; and
sending, by the session managing node (118) to the user data managing node (116), one of:
a) a first error response when NAT exposure is not supported by any NAT information exposing node (120) for the PDU session of the UE; and
b) a first service response when the NAT exposure is supported for the PDU session of the UE in the NAT information exposing node, wherein the first service response comprises the external IP address of the PDU session of the UE, wherein the external IP address comprises one of:
i) NATed IP address of the PDU session of the UE when NATed IP address of the PDU session of the UE was received from the NAT information exposing node (120) when NATing is enabled for the PDU session of the UE; and
ii) private IP address of the PDU session of the UE when an error was received from the NAT information exposing node (120) indicating that NATing is not enabled for the requested PDU session of the UE.

19. The method as claimed in claim 18, wherein sending, by the session managing node (118), the first service response when the NAT exposure is supported in the NAT information exposing node (120) comprises:
sending, by the session managing node (118) to the NAT information exposing node, a fourth service request with a fourth plurality of attributes, for retrieval of the NATed IP address of the PDU session of the UE when the NAT exposure is supported for the PDU session of the UE in the NAT information exposing node, wherein the fourth plurality of attributes comprises a private IP address of the UE, the IP address of a remote end, an indicator for immediate reporting and an event indicating the request for NATed IP address of the PDU session of the UE; and
receiving, by the session managing node (118) from the NAT information exposing node, one of:
a) a second service response comprising the NATed IP address of the PDU session of the UE when NATing is enabled for the PDU session of the UE and generating, by the session managing node (118), the first service response comprising the NATed IP address of the PDU session of the UE to the user data managing node (116); and
b) a second error response when NATing is not enabled for the PDU session of the UE and generating, by the session managing node (118), the first service response comprising the private IP address of the PDU session of the UE to a service consumer node (114).

20. The method as claimed in claim 19, further comprises:
sending, by the user data managing node (116) to the network exposure gateway node (104a), one of:
a) a third error response when the first error response is received; and
b) a third service response comprising external IP address of the UE, when first service response is received.

21. The method as claimed in claim 20, further comprises:
sending, by the network exposure gateway node (104a) to the AF node (106), one of:
a) a fourth error response, when the third error response is received; and
b) a fourth service response, comprising the external IP address of the UE, when the third service response is received.

22. The method as claimed in claim 19, wherein the first service request, in 5G network, is one of:
Nnef_UeAddress_Get service operation when network exposing gateway node receives a request for the retrieval of the external IP address of an ongoing PDU session of a UE, and
Nnef_UeAddress_Subscribe service operation when network exposing node receives a request for retrieval of the external IP address of the one or more UEs, targeting one of an ongoing and a future Protocol Data Unit (PDU) session; and
wherein the second service request, in the 5G network, is one of:
Nudm_UECM_Get service operation when the user data managing node (116) receives a request for the retrieval of the external IP address of an ongoing PDU session of a UE, and
Nudm_EventExposure_Subscribe service operation when the user data managing node (116) receives a request for retrieval of the external IP address of one of an ongoing and a future PDU session of the one or more UEs; and
wherein the third service request, in the 5G network, uses Nsmf_EventExposure API; and
wherein the fourth service request, in 5G network, uses Nupf_EventExposure API with EventType set to “UE_NAT_MAPPING_INFO”.

23. A session managing node (118) for optimizing retrieval of an external Internet Protocol (IP) address of a User Equipment (UE) in a communication system (1000), comprising:
a memory (1030);
a processor (1020); and
an external IP address controller (1010), connected to the memory (1030) and the processor (1020), wherein the external IP address controller (1010):
receives, from a service consumer node (114), a first service request for retrieval of the external IP address of a Protocol Data Unit (PDU) session of the UE, wherein the first service request comprises an identifier of the UE and first plurality of attributes, wherein the first plurality of attributes comprises a Subscription Permanent Identifier (SUPI), a Protocol Data Unit (PDU) session identifier, an IP address of a remote end, and at least one of an indicator and an event ID requesting for the external IP address of the UE;
determines a Network Address Translation (NAT) information exposing node that provides the NAT information of the PDU session of the UE; and
sends a first service response to the service consumer node (114); wherein the first service response is one of:
a) a response comprising the external IP address of the PDU session of the UE, when NAT exposure is supported by the NAT information exposing node (120) for the PDU session of the UE, wherein the external IP address comprises one of:
i) NATed IP address of the PDU session of the UE received from the NAT information exposing node; and
ii) private IP address of the PDU session of the UE when an error was received from the NAT information exposing node;
b) an error response indicating that the external IP address of the PDU session of the UE cannot be retrieved, when NAT exposure is not supported by any NAT information exposing node (120) for the PDU session of the UE.

24. A user data managing node (116) for optimizing retrieval of an external Internet Protocol (IP) address of User Equipment (UE) in a communication system (1000), comprising:
a memory (1030);
a processor (1020); and
an external IP address controller (1010), connected to the memory (1030) and the processor (1020), wherein the external IP address controller (1010):
receives, from a service consumer node (114), a first service request for retrieval of the external IP address of the one or more UEs, targeting one of: an ongoing and a future Protocol Data Unit (PDU) session of the one or more UEs, wherein the first service request comprises first plurality of attributes, wherein the first plurality of attributes comprises at least one of a General Public Subscription Identifier (GPSI) and a Subscription Permanent Identifier (SUPI), Data Name Network (DNN), an IP address of a remote end, and at least one of an event and an indicator requesting for the external IP address of the PDU session of a UE of the one or more UEs;
stores the first service request; and
sends, a first service response to the service consumer node (114), wherein the first service response comprises one of:
a. an error response; and
b. a service response comprising the external IP address of the UE.

25. A network exposure gateway node (104a) for optimizing retrieval of an external Internet Protocol (IP) address of a User Equipment (UE) in a communication system (1000), comprising:
a memory (1230);
a processor (1220); and
an external IP address controller (1210), connected to the memory (1230) and the processor (1220), wherein the external IP address controller (1210):
receives, from an Application Function (AF) node, a first service request for retrieval of the external IP address of the one or more UEs, targeting one of an ongoing and a future Protocol Data Unit (PDU) session, wherein the first service request comprises first plurality of attributes, wherein the first plurality of attributes comprises of a General Public Subscription Identifier (GPSI) of the one or more UEs, an AF identifier, an IP address of a remote end, and an indicator requesting for the external IP address of the PDU session of a UE of the one or more UEs; and
sends, to the AF node (106), a first service response comprising one of:
a. a service response comprising the external IP address of the UE; and
b. an error response, when the external IP address of the UE cannot be retrieved.
